(19) United States
(12) Patent Application Publication
(10) Pub. No.: US 2008/0220869 A1
(43) Pub. Date: Sep. 11, 2008

(54) METHOD AND APPARATUS FOR PROVIDING GAME GUIDE DATA IN A GAMING ENVIRONMENT

(76) Inventors: Timothy Michael Midgley, Dallas, TX (US); David Patterson Tuttle, Dallas, TX (US); James Yeh Yang, Richardson, TX (US)

Correspondence Address: DUKE W. YEE, YEE & ASSOCIATES, P.C., P.O. BOX 802333, DALLAS, TX, 75380, US

(21) Appl. No.: 11/683,802

(22) Filed: Mar. 8, 2007

(51) Int. Cl. A63F 13/00

(52) U.S. Cl. 463/40; 463/43; 715/738

(57) ABSTRACT

A computer implemented method, a data processing system, and a computer program product for presenting a user guide for supplementing game play. An exemplary method includes querying a source of data containing game guide data corresponding to a game. The game is executing on a data processing system. The source of data is external to the game. The method also includes presenting, while the game is executing in a foreground, the game guide data to the user in a dynamic window.

### BACKGROUND OF THE INVENTION

1. Technical Field

The present invention relates generally to a gaming environment. In particular, the present invention relates to game play in a gaming environment. Still more particularly, the present invention relates to monitoring user game-playing behavior and reporting game play data in a gaming environment.

2. Description of Related Art

With the rise of the Internet, gamers all over the world are able to interactively play games online without the restriction of location and/or time differences. Via an online gaming community, gamers can share information about games as well as other interests relating to gaming, such as, usability, desired features, and the like. For game companies who manufacture these games, interests of gamers become a useful source of information relating to marketing, development, and production of games. The interests of gamers also generate statistics that help companies to identify sales trends. Examples of useful statistics include sales figures based on geographic, rate, and price to sales ratio.

Gaming community software, such as GamerMetrics, performs analysis of gamer interests for game companies. GamerMetrics is a product available from ING Entertainment, Inc. GamerMetrics mainly deals with gamer activities through the phases of the game-buying cycle. GamerMetrics collects factors from a sample of garners that drive their decisions towards purchasing the game. However, after the game is purchased, no analysis is performed by GamerMetrics because it only monitors gamer activities up to the point of sale. While other online gaming community software provides some data after the point of sale, this data is mostly biased because either a game is being promoted or a fee is charged for playing. In addition, true gaming activities are not verified by current gaming community software. For example, a user with a monthly subscription may be logged into the game server for two days, but only actively played the game for two hours.

While presale data is important to game companies in determining what type of games to manufacture, post sales data is equally important in monitoring future sales trends. Post sales data enables analysis of gamers' post sales behavior and what goes on after garners purchase the game. Some questions that post sales data may answer include how much the game is being played, how long the game is being played, over what period of time after the point of sale the game is played (days, weeks, months, years), who is playing the game (demographic), and where the game is played (geographic).

In addition, post sales data helps to provide insight to the popularity and longevity of the game. This post sales information may be useful in determining whether a sequel should be developed, correlations to other compatible games in the market, what type of target audience to focus on, decisions to pursue future development of game titles, detailed demographic targeting for future games, timing for such future developments, as well as budgeting and marketing constraints for developing future games. Currently, no solution exists that provides such post sale data. In addition, no solution exists for monitoring game play data while the gamers are offline. Solutions like GamerMetrics only provide analysis while the games are played online. Furthermore, no solution exists that provides a single-player game play data that is non-biased because other solutions only provide game play data of two or more gamers while they are playing a game that is being promoted.

Furthermore, the participation of gamers in services like IGN's GamerMetrics and Gamespy hinge on the fact that the service is provided for a fee. Gamers may participate in these services, regardless of single or multiplayer environments. The point is that the data collected from these gamers' activities is still being sourced from a network server IGN operates and facilitates. The vast majority of game usage falls into private use, which can be offline use, or online private network use for single and multiplayer gaming.

### SUMMARY OF THE INVENTION

The aspects of the present invention provide a computer implemented method, a data processing system, and a computer program product for presenting a user guide for supplementing game play. An exemplary method includes querying a source of data containing game guide data corresponding to a game. The game is executing on a data processing system. The source of data is external to the game. The method also includes presenting, while the game is executing in a foreground, the game guide data to the user in a dynamic window.

The aspects of the present invention provide a computer implemented method, a data processing system, and a computer program product for monitoring game play behavior of a user in an online gaming environment. Responsive to detecting execution of a game, gaming characteristics of the user are monitored. The game interacts with a game server. Game play data of the user is collected. A plug-in application, located on the game server, collects game play data.

The aspects of the present invention also provide a computer implemented method, a data processing system, and a computer program product for monitoring user game play behavior and reporting game play data in a gaming environment. Gaming characteristics of a user are monitored upon a launch of a game. A game state is identified based on the gaming characteristics. The game play data of the user is collected if any change in the game state occurs and the game play data is reported for processing.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with an illustrative embodiment of the present invention;

FIG. 3 is a diagram illustrating interactions between components of the present invention in accordance with an illustrative embodiment of the present invention;

FIG. 4 is a flowchart of a process for collecting user game play data and crediting users in accordance with an illustrative embodiment of the present invention;

FIG. 5 is a flowchart of a process for processing user game play data in accordance with an illustrative embodiment of the present invention;

FIG. 6 is a flowchart of a process for managing spending of account credits by the user in accordance with an illustrative embodiment of the present invention;

FIG. 7 is a use case diagram illustrating use cases performed by a gamer, a software agent, a database server, a Web server, and a chat server in accordance with an illustrative embodiment of the present invention;

FIGS. 8A-8B are activity diagrams illustrating activities performed by a gamer, a software agent, a server, and a chat server in accordance with an illustrative embodiment of the present invention;

FIG. 9 is a flowchart of a process for determining a game state in accordance with an illustrative embodiment of the present invention;

FIGS. 10A-10C are diagrams illustrating activities and data involved when validating, storing, and transporting user game play data in accordance with an illustrative embodiment of the present invention;

FIGS. 11A-11B are class diagrams illustrating exemplary classes used to implement the aspects of the present invention in accordance with an illustrative embodiment of the present invention;

FIGS. 12A-12B are activity diagrams illustrating chat functionality in accordance with an illustrative embodiment of the present invention;

FIG. 13A is a flowchart of a process for collecting user game play data from a game from the perspective of a server in accordance with an illustrative embodiment;

FIG. 13B is a flowchart of a process for collecting user game play data from a game from the perspective of a software agent in accordance with an illustrative embodiment;

FIG. 14 is a flowchart of a process for configuring a software agent to operate in an online environment in accordance with an illustrative embodiment;

FIG. 15 is a flowchart of a process of entering tournament mode of a software agent to operate in an online environment, in accordance with an illustrative embodiment;

FIG. 16 is a flowchart of a process for collecting game play data in an online environment in accordance with an illustrative embodiment

FIG. 17 is a flowchart illustrating a process of storing a prompt rule set for a challenge prompt in accordance with an illustrative embodiment;

FIG. 18 is a flowchart of a process for issuing a challenge prompt to a user during game play in accordance with an illustrative embodiment;

FIG. 19 is a flowchart of a process for crediting a user with account credits as a result of game play in an online environment in accordance with an illustrative embodiment;

FIG. 20 is a flowchart of a process for configuring a software agent to provide a user with game guide data during game play in accordance with an illustrative embodiment;

FIG. 21 is a flowchart of a process for displaying game guide data during game play in accordance with an illustrative embodiment;

FIG. 22 is a use case diagram illustrating use cases performed by a gamer user, a software agent, a server, and a data store in accordance with an illustrative embodiment;

FIGS. 23A-23B are class diagrams illustrating exemplary classes used to implement aspects of the present invention in accordance with an illustrative embodiment;

FIG. 24 is a class diagram illustrating exemplary classes used to implement aspects of the present invention in an online environment in accordance with an illustrative embodiment; and

FIG. 25 is a class diagram illustrating exemplary classes used to implement display of a dynamic interactive window during game play in accordance with an illustrative embodiment.

### DETAILED DESCRIPTION OF THE PREFERRED EMBODIMENT

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

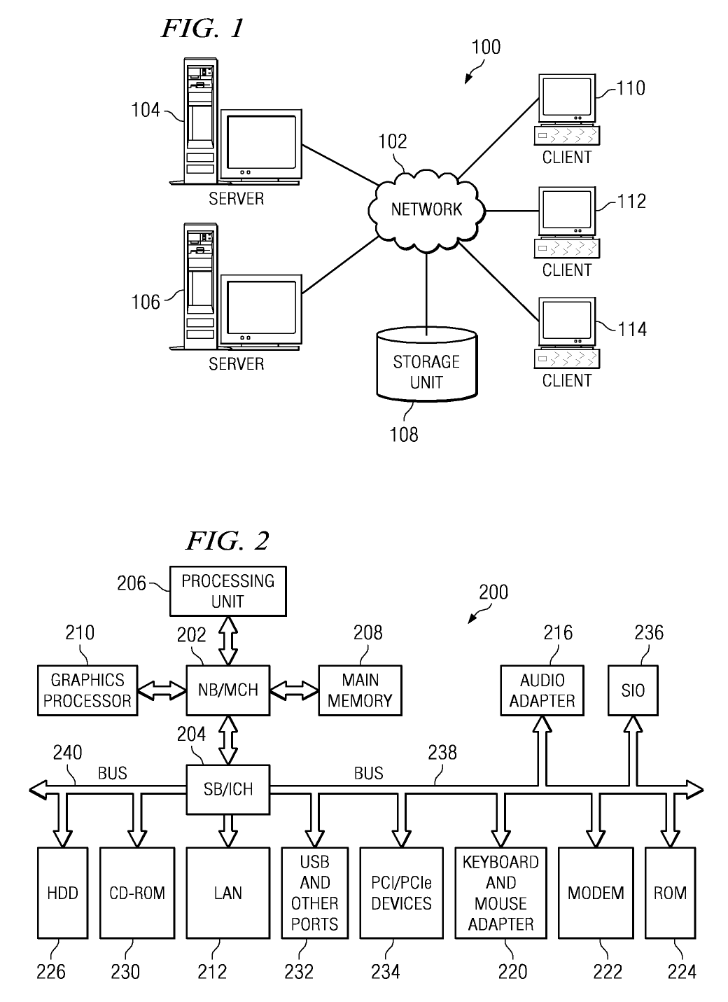

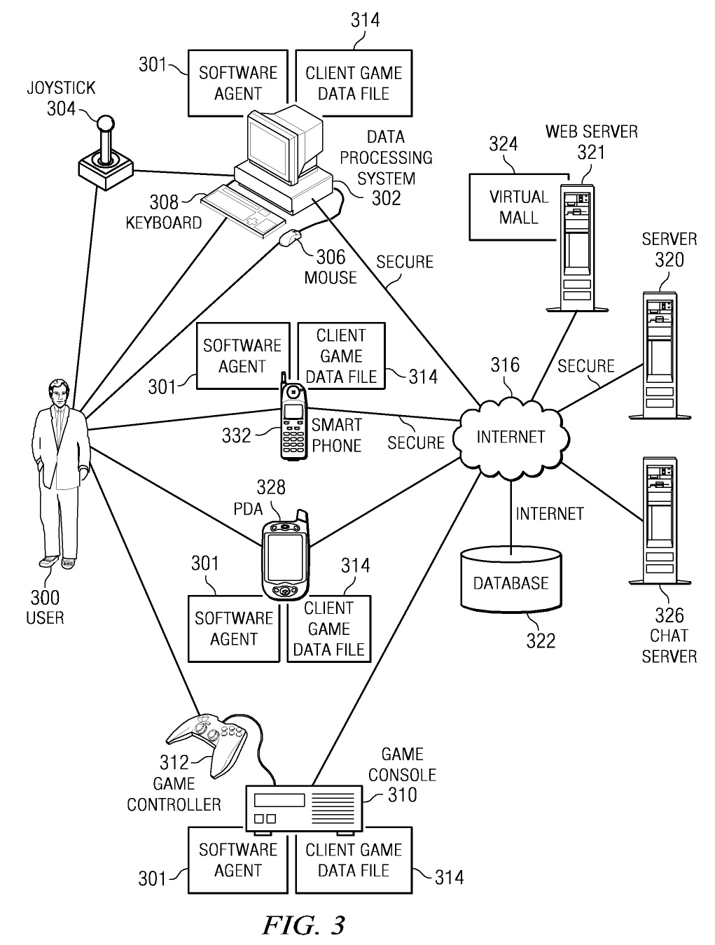

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Server 104 may be, for example, a gamer server that hosts games that are played by users at clients 110, 112, and 114. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to SB/ICH 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention monitor user game play behavior and report the game play data. In order to generate game play data from users, one aspect of the present invention provides a software agent that users can download and install on their gaming systems. Gaming systems include computer systems, such as data processing system 200 in FIG. 2, or any other game entertainment systems that support downloading or installation of code. Examples of game entertainment systems include Playstation®2 available from Sony Computer Entertainment America Inc. or XBox® available from Microsoft Corporation. The software agent accurately monitors certain gaming characteristics to determine whether the user is actively playing a game and collects user game play data if the user's state changes. Examples of gaming characteristics that the software agent monitors include mouse usage, joystick usage, keyboard usage, user CPU utilization, user active window, user memory usage, user network connectivity, and the like.

User game play data is data that reflects how users are playing the game. Before a user starts playing a game, the user activates the software agent to collect game play data. When the software agent determines that the user is actively playing a game based on the gaming characteristics, or that any change in game state has occurred, the software agent collects user game play data and continues to monitor user game play behavior. Alternatively, the software agent may automatically activate when the user starts a game. Examples of user game play data include playtime duration, time of the day the game is played, the title of the game played, and other performance statistics. Unlike other common gaming community software, the software agent of the present invention may collect both online and offline user game play data.

User game play data is user game play data that is collected while the software agent is running. The user may be playing a game remotely while connected to the Internet or locally on a personal computer without connecting to the Internet. The software agent of the present invention may collect online user game play data remotely or offline user game play data locally. The user game play data may be used to create dynamic services for purposes of interactive tips and hints as well as a dynamic user interface for purposes of communication amongst users. Dynamic services that are created include, for example, without limitation, competitive leagues, tournament competition, and statistical competitions.

Any time after the software agent collects online and/or offline user game play data, the software agent may communicate with a server to store and process the user collected data provided that a network connection is available. If a network connection is not always available, the game play data is stored and transmitted at a time when the network connection becomes available. In most cases, the network connection is one that is indirectly or directly connected to the Internet. In these examples, the software agent and the server communicate with each other via a secure communication protocol, for example, simple object access protocol (SOAP) over secure hypertext transfer protocol (HTTPS). SOAP is an established protocol that is based on sending markup language messages between hosts. HTTPS is a secure means for transferring data using the hypertext transfer protocol (HTTP). HTTPS uses a 40-bit encryption or 128-bit encryption. In one illustrative embodiment, aspects of the present invention provide a Web service on top of SOAP that customizes the markup language messages being sent between the server and the client. Formats of the markup language messages are defined using a customized Web Services Description Language (WSDL) file.

The software agent and the server deliver both static and dynamic data to each other. Static data includes agent skin files, a game list, a rule set, and other configuration files for configuring the software agent. Dynamic data includes streaming statistics, a chat buddy list, buddy statuses, local user status (active, idle, or inactive), and real time performance statistics. An agent skin file is an image file layered over an application window to customize the window's look and feel. In cases where a network connection is not available, the collected user game play data is accumulated locally in a client game play data file until a network connection is detected. In cases where the network connection is available, the client game play data is still accumulated locally. However, the client game data is actively sent to the server based on defined threshold limits. For example, if the user is online, and has accumulated ten updates, those updates are sent to the server and the client game play data file is reset. This means that the client game data includes game data that is stored to a local device, and/or other game data that is being streamed to the server at real time.

After the server receives the collected user game play data from the software agent, the server processes the data accordingly. The processing of data includes updating the collected game play data into a database. In an illustrative embodiment, the database includes all game play data that is collected for different users. Based on the updated data in the database, another aspect of the present invention manages the user's personal account. The user's personal account includes account credits that the user may use to redeem products and/or services in a virtual mall.

The management of the user's personal account includes crediting the user with account credits and managing the spending of the account credits in a virtual mall. The user may spend their account credits on products and/or services that are offered in the virtual mall. The crediting of account credits may be based on cumulative real time game play data, for example, a total amount of time spent on the game. The crediting of account credits may also be based on incentives, for example, the number of points scored by the user for the game. In addition to the amount of time spent and the number of points scored, other types of incentives, including kills, levels, mission completion, status, and wins may also be used in crediting the users.

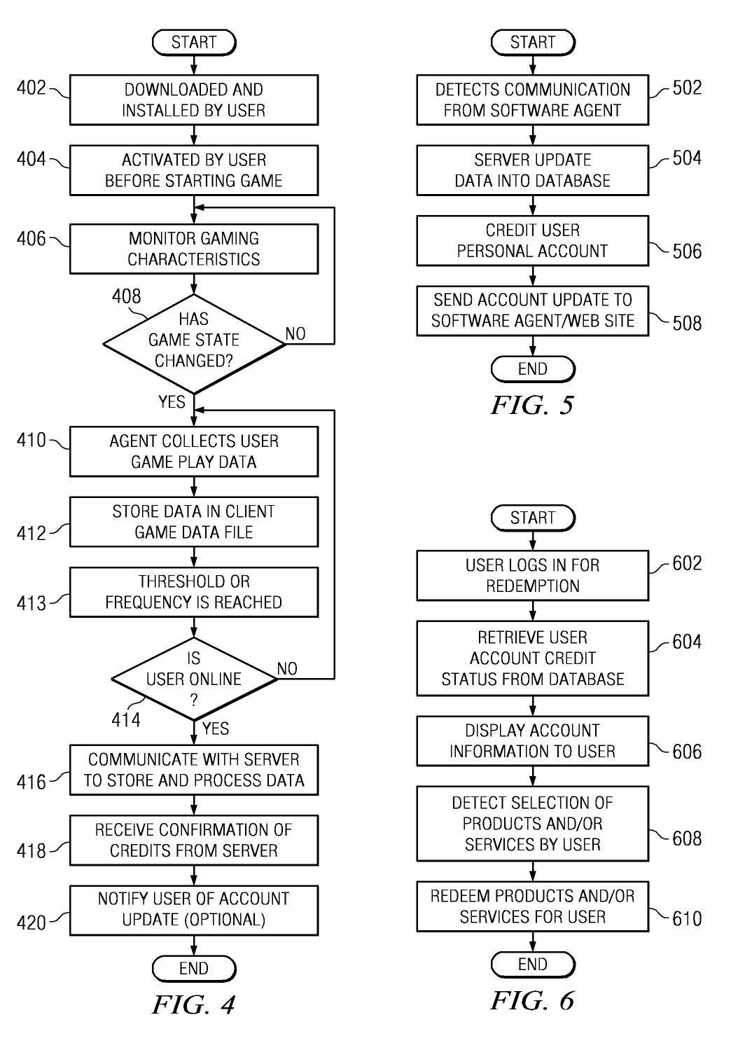

Turning now to FIG. 3, a diagram illustrating interactions between components of the present invention is depicted in accordance with an illustrative embodiment of the present invention. As shown in FIG. 3, software agent 301 of the present invention may be implemented within data processing system 302 or game console 310. Data processing system 302 may be implemented as data processing system 200 in FIG. 2. Game console 310 may be implemented as a game entertainment system, such as Playstation®2 available from Sony Computer Entertainment America Inc. or XBox® available from Microsoft Corporation.

In order to generate user game play data, software agent 301 monitors certain gaming characteristics to determine whether user 300 is actively playing a game. These gaming characteristics include mouse usage, joystick usage, keyboard usage, user processor utilization, user active window, user memory usage, user network connectivity, and the like. Software agent 301 obtains mouse usage by regularly querying the physical state of the mouse 306. Similarly, keyboard and joystick usage are obtained by regularly querying the physical state of the keyboard 308 and joystick 304. In addition, software agent 301 may obtain usage of other input devices by regularly querying the physical state of the hardware devices, for example, personal digital assistant (PDA) 328 and smart phone 332.

Other gaming characteristics, such as user processor utilization, user active window, user memory usage, and user network connectivity may be determined from an operating system currently executing on data processing system 302 without intruding user 300. The operating system of data processing system 302 provides an interface that allows software agent 301 to extract these gaming characteristics. An example of such operating system is Windows® XP, a product available from Microsoft Corporation. If software agent 301 is implemented in game console 310, gaming characteristics may include, for example, game controller usage obtained from inputs by user 300 to game console 310 via game controller 312.

Based on the gaming characteristics, software agent 301 determines whether user 300 is actively playing a game. In the illustrative examples, software agent 301 constantly monitors changes in game state, and constantly collects data regarding changes in those states. For example, software agent 301 collects client game data when the state changes from idle to active, from active to inactive, from inactive to idle, and the like. The user game play data is data that reflects how user 300 is playing the game. This user game play data includes the game title being played, a username, the duration of time played, and other statistical and performance data, such as the total number of points scored. Performance statistics may include any relevant measure of success with respect to the game being played.

The game play data collected by software agent 301 is unique in that the user game play data is entirely post sales data that is sampled under unsupervised circumstances. This user game play data is advantageous over data that is currently collected by other game community software, because this data provides information that is not otherwise available after the point of sale. Even if the information is available after the point of sale, it is usually skewed or biased and does not account for active game playing. The user game play data that is collected by software agent 301 not only reflects what currently goes on after the point of sale, but also helps companies in predicting future trends of game playing. The number of units sold can be very different from the number of units played. With software agent 301, the number of units actually played may be determined based on certain gaming characteristics. Thus, useful post sales market research data may be provided to various industry stakeholders, including game media planners or buyers, game publishers, game developers, game industry analysts, and other game industry professionals for analysis.

The post sales data that is provided by aspects of the present invention is unbiased and shows the true nature of post game activities, not just participation through dedicated services provided by vendors. Using an analogy with determining the desires and behavior of consumer eating, data from a restaurant or buffet would be somewhat skewed. In a restaurant, the provider specializes in certain dishes. Thus, the data collected by restaurant would be skewed to what the restaurant offers. Similarly, in a buffet, the quantity and selection of food eaten would be skewed to overeating. A better way to collect data instead would be to examine individual eating tendencies over a long period of time during private dining as well as serviced dining. In this way, the data collected is not skewed or biased based on the type of food the restaurant or buffet offers.

In addition to the uniqueness of the user game play data collected, software agent 301 provides an advantage over current gaming community software in that software agent 301 may collect user game play data both online and offline. Current gaming community software mostly collects user game play data while the user is playing a game online with another user either over the Internet or across local networks. For user game play data that is collected between users while they are online, this user game play data may be skewed or biased and does not reflect active game playing. For user game play data that is collected between users while they are playing across local networks, this user game play data is not readily available for monitoring by outside sources. In addition, current gaming community software fails to collect user game play data for a single-player game that may occur offline, since most gaming community software collects user game play data only during game playing of two or more users.

As the user game play data is collected, software agent 301 determines whether a network connection is available in either data processing system 302 or game console 310. If a network connection is available, software agent 301 sends the collected data accumulated in client game data file 314 on data processing system 302 or game console 310 to server 320 via Internet 316 using a secure communication protocol, such as, SOAP over HTTPS. The software agent 301 sends the collected user game play data accumulated in client game data file 314 to server 320 based on a pre-determined threshold and frequency, for example, every ten minutes. If no network connection is available, the collected user game play data continues to be accumulated in client game data file 314 on data processing system 302 or game console 310 until a network connection is detected. Once a network connection is detected, the data is sent in small batches. Client game data file 314 collects user game play data while user 300 is playing a game offline or online.

Once the collected data is received, server 320 extracts the collected user game play data and processes it. Server 320 processes the collected user game play data by updating the data in database 322 with the existing game play data. Server 320 may send the collected user game play data to database 322 via an Internet connection. Database 322 includes a history of game play data that is collected from different users. Once server 320 updates the collected data into database 322, the data may be used by another aspect of the present invention to perform different business functions.

For example, one business function that may be performed by the aspect of the present invention is to send dynamic statistics derived from the updated data directly to software agent 301 and/or Web pages on data processing unit 302 or game console 310. In this way, user 300 may receive immediate feedback as to the status of the user's personal account.

Another business function that may be performed by the aspect of the present invention is to manage the user's personal account. The personal account includes account credits that the user may use to redeem products and/or services. The aspect of the present invention may credit the user with account credits and manage the spending of the account credits in virtual mall 324 that is provided by another aspect of the present invention.

Virtual mall 324 includes a variety of products and/or services that are available for redemption by the users. Virtual mall 324 may be implemented in a Web server, such as Web server 321. User 300 may interact with virtual mall 324 via data processing system 302. Examples of products and services that are offered in virtual mall 324 include consumer electronics, entertainment software, food or restaurant vouchers, and film related products, such as movie tickets.

As discussed above, the user may spend their account credits on products and/or services that are offered in virtual mall 324. The crediting of account credits may be based on cumulative real time game play data, for example, a total amount of time the user spent playing the game, or incentives, for example, the number of points the user scored in the game. In addition to the above, software agent 301 also facilitates chat functionalities between user 300 and other users by communicating with chat server 326 via Internet 316.

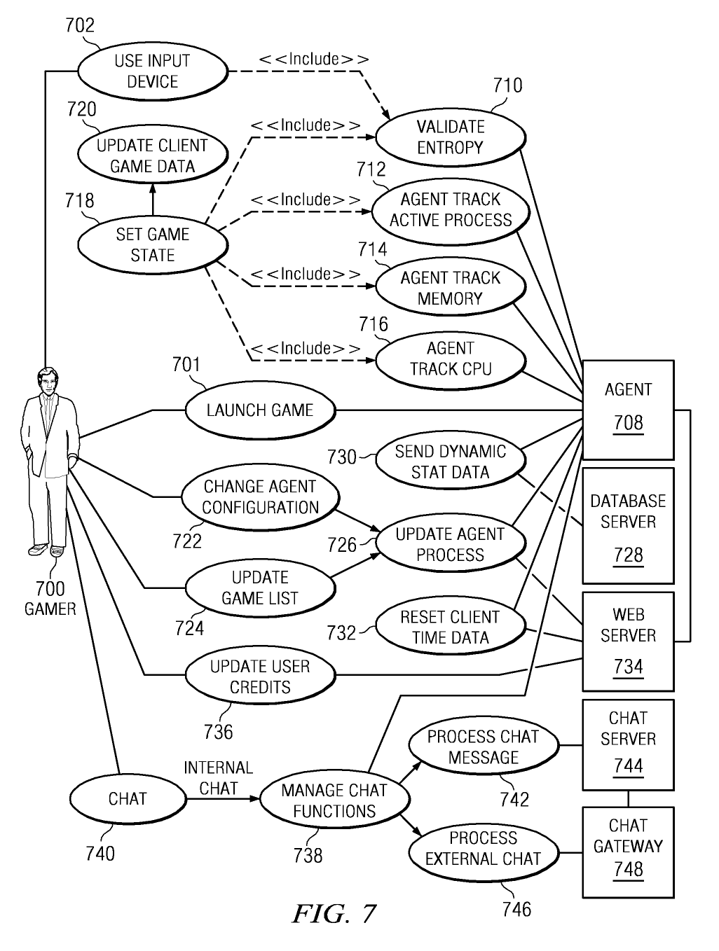

Turning now to FIG. 4, a flowchart of a process for collecting user game play data and crediting users is depicted in accordance with an illustrative embodiment of the present invention. This exemplary process may be implemented in a software agent, such as software agent 301 in FIG. 3. As shown in FIG. 4, from the perspective of the software agent, the process begins when the software agent is downloaded by a user and installed on a data processing system or a game console (step 402).

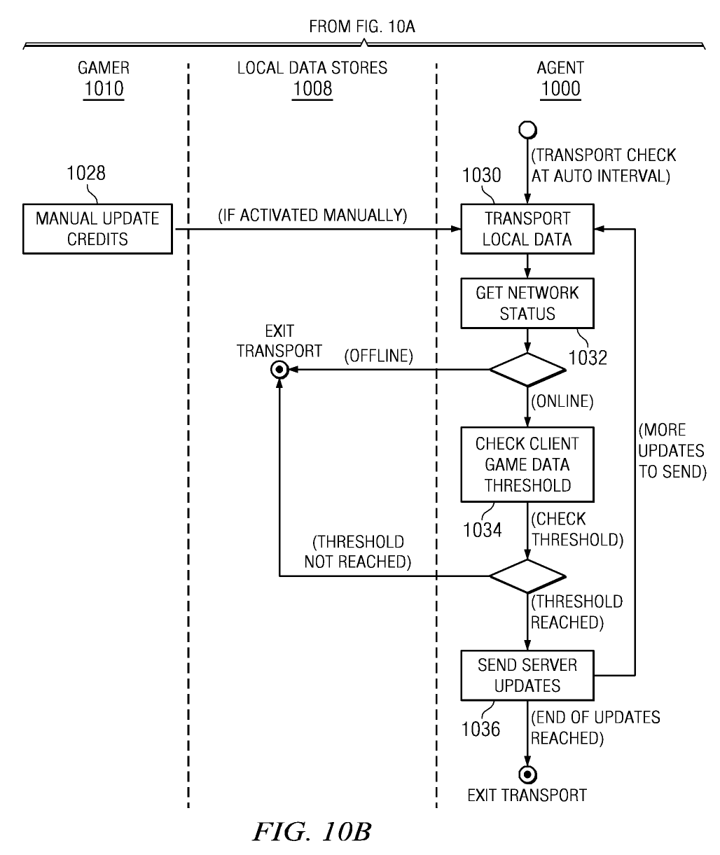

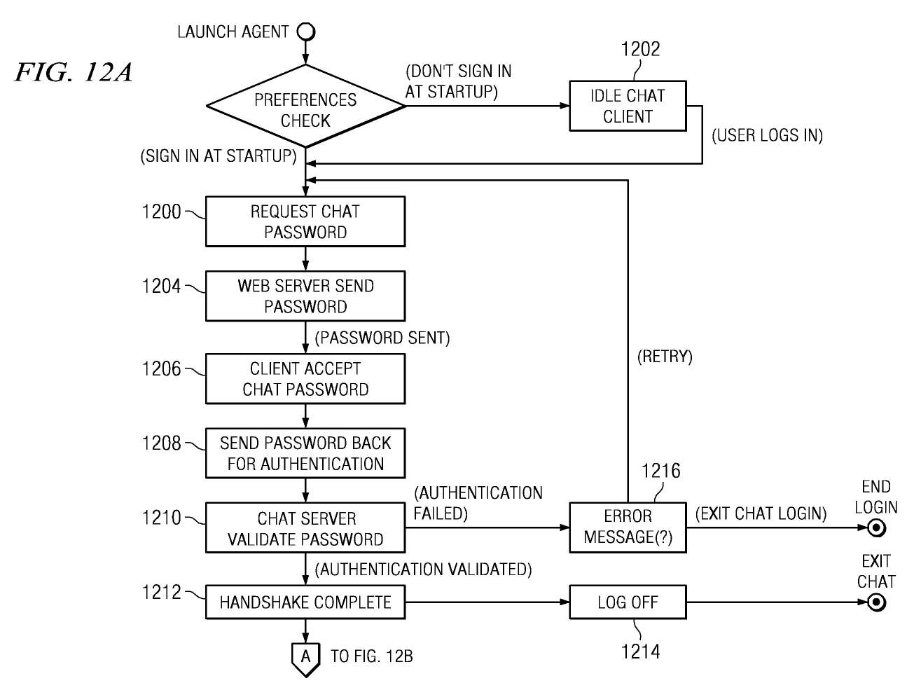

Next, the software agent is activated by the user before starting a game (step 404). The software agent then monitors certain gaming characteristics (step 406). A determination is then made by the software agent as to whether the game state changes based on the characteristics (step 408). More details regarding how the determination is made by the software agent is discussed in FIGS. 9A and 9B. If the game state changes, the software agent collects that game play data (step 410) and stores the collected data in the client game data file (step 412). More details regarding how the software agent collects user game play data is discussed in FIGS. 13A and 13B. If the game state does not change, the software agent returns to step 406 to continue monitoring the gaming characteristics and step 408 to determine if the game state has changed.

The software agent cumulatively collects user game play data and stores the data in the client game data file. Once the threshold for update count and/or frequency has been met (step 413), the software agent then makes a determination as to whether the user is currently online (step 414). The determination is made based on whether a network connection is available in data processing system 302 or in game console 310 in FIG. 3. If the user is currently online, the software agent communicates with a server to store and process the collected data (step 416). If the user is offline, the process returns to step 410 to cumulatively collect user game play data and step 412 to cumulatively store the data.

The accumulated data may be stored in a client game data file in the user's system, such as data processing system 302 or in game console 310 in FIG. 3. Later, the software agent may request an update of the user's personal account and receive confirmation of credits from the server (step 418). The software agent in turn may notify the user of the account update (step 420). Step 420 is an optional step and the process terminates thereafter.

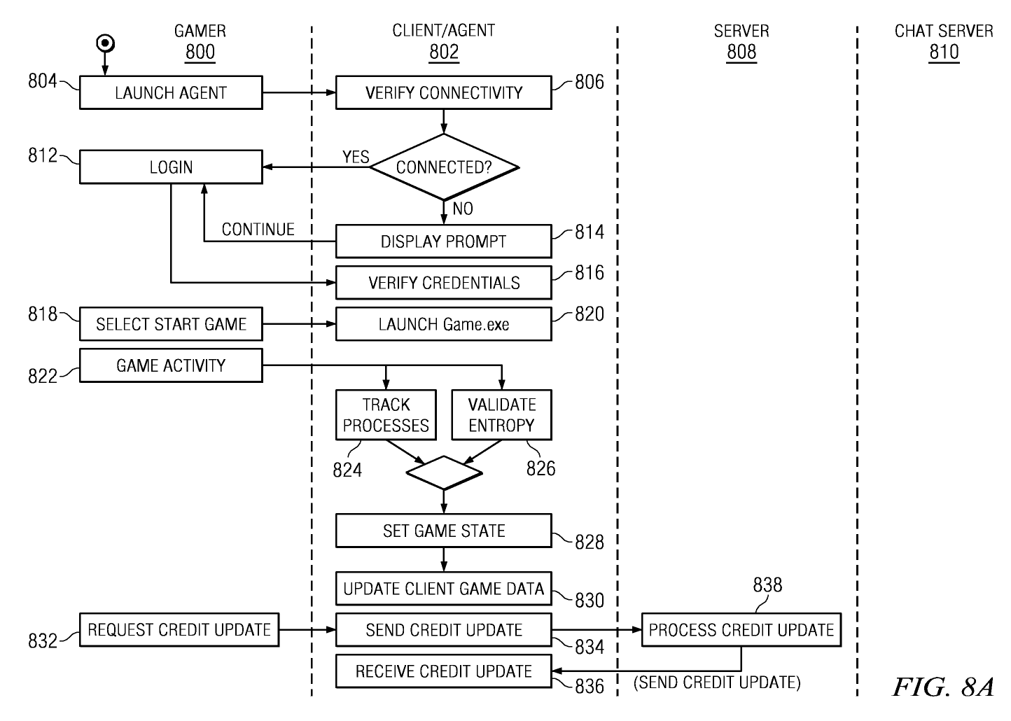

Turning now to FIG. 5, a flowchart of a process for processing user game play data is depicted in accordance with an illustrative embodiment of the present invention. This exemplary process may be implemented in a server, such as server 320 in FIG. 3. As shown in FIG. 5, from the perspective of the server, the process begins after the software agent communicates with the server at step 416 in FIG. 4. The process begins with the server detecting a communication from the software agent (step 502). In turn, the server updates the collected data into a database (step 504). The database includes a history of game play data for different users.

Once the database is updated with the collected data, the server may credit the user's personal account based on the collected data (step 506). The server may credit the user's personal account based on cumulative real time game play data, for example, a total amount of time spent on the game. The crediting of account credits may also be based on incentives, for example, the number of points scored by the user for the game. Later, the user may request an update of the personal account; the server then sends an update of the account to a software agent or a Web site (step 508).

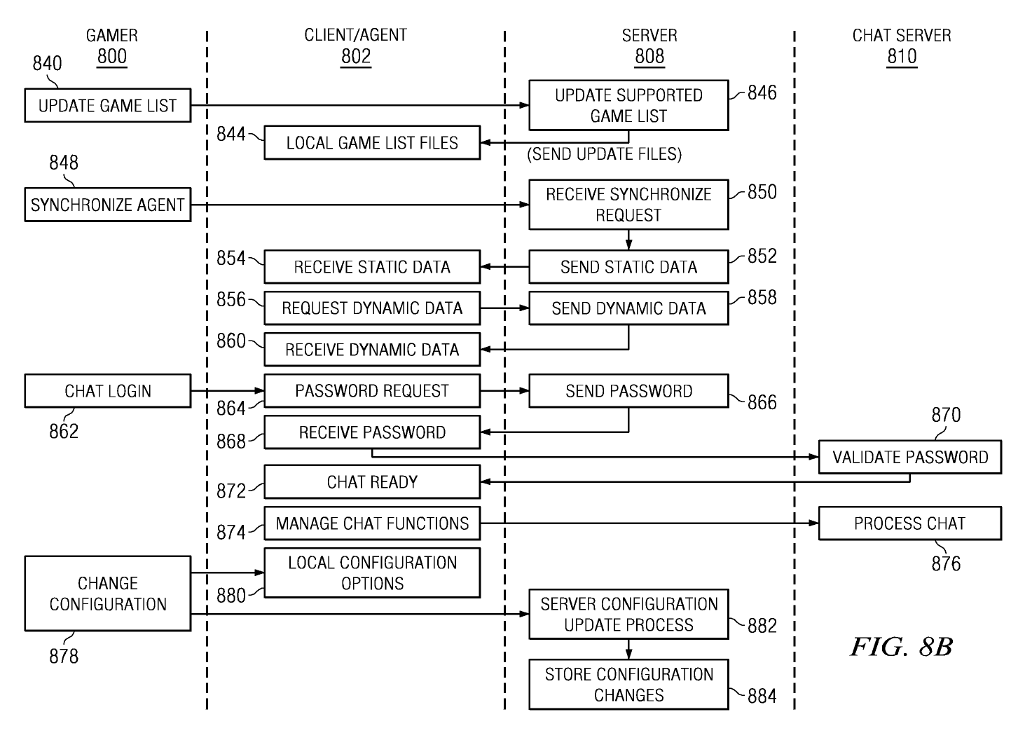

Once account credits are credited to a user's personal account, the user may either view their credit balance or redeem their account credits for products and/or services in a virtual mall. Another aspect of the present invention manages the spending or redeeming of account credits in that virtual mall. Turning now to FIG. 6, a flowchart of a process for managing spending of account credits by the user is depicted in accordance with an illustrative embodiment of the present invention. This exemplary process may be implemented in a Web server, such as Web server 321 in FIG. 3. As shown in FIG. 6, from the perspective of the Web server, the process begins when the user logs in to the virtual mall for redemption (step 602). Next, the Web server retrieves the data that is updated in the database (step 604). In turn, the Web server displays the account information to the user (step 606). This step may be implemented by displaying an advertisement to inform the user that credits are present for redemption. For example, the credits may be given to the user because the amount of time that the user spent playing the game exceeds a certain threshold.

After the account information is displayed, the Web server may detect the user's selection of products and/or services available in the virtual mall (step 608). In turn, the Web server redeems the selected products and/or services for the user (step 610). Thus, the process terminates thereafter.

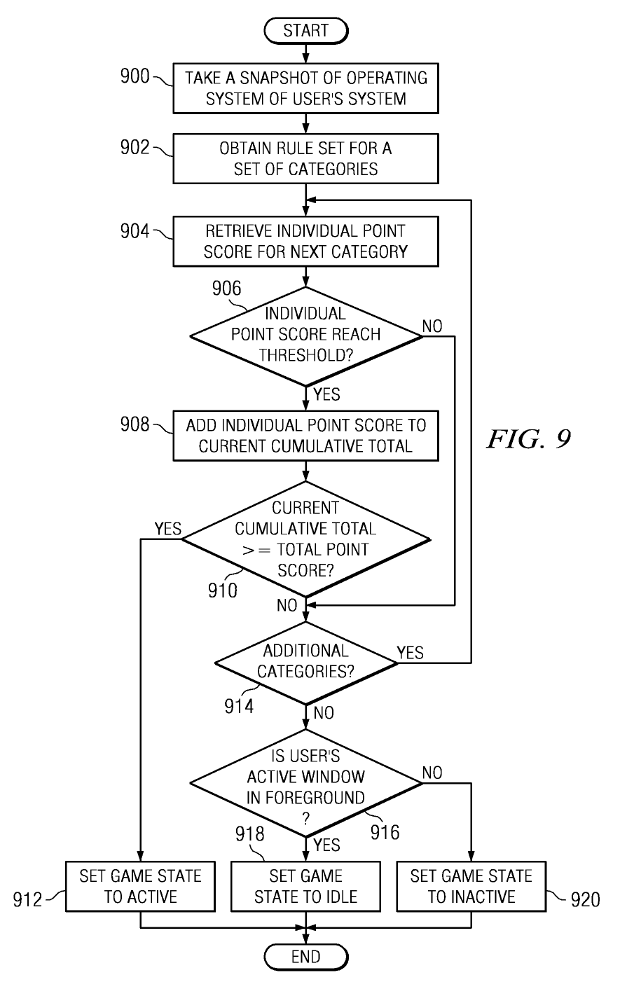

Turning now to FIG. 7, a use case diagram illustrating use cases performed by a gamer, a software agent, a database server, a Web server, and a chat server is depicted in accordance with an illustrative embodiment of the present invention. As shown in FIG. 7, gamer 700, interacts with a game by user input device 702, which include moving a joystick, a keyboard, or mouse. Gamer 700 may also use other types of input gaming devices, including game controller, without departing the spirit and scope of the present invention.

Gamer 700 can launch game 701, once agent 708 is activated. Agent 708 monitors the movement of input devices, including joystick, keyboard, and mouse, to determine whether gamer 700 is actively playing the game. These characteristics are known as user inputs and the use case for determining the user inputs by the software agent is referred to as validate entropy 710. In addition to validate entropy 710, agent 708 also tracks other gaming characteristics to determine whether the user is actively playing the game. These characteristics include active process 712, memory usage 714, and CPU 716 utilization. These characteristics may be obtained from an interface provided by the operating system of data processing system 302 or game console 310 in FIG. 3 that gamer 700 is currently using.

In determining whether the user is active, idle, or inactive, agent 708 also uses predefined algorithms and artificial intelligence in a rule set file. The rule set file may be implemented as a generic plug-in that agent 708 can easily interface with. A rule set defines a threshold limit for each attribute or characteristic that is monitored by the software agent. By defining a threshold limit for each attribute, game companies or resources may specify different criteria for monitoring user behavior.

The rule set may be defined as GameName, GameID#, threshold_{—}0, threshold_{—}1, . . . , threshold_N. GameName indicates the name of the game being monitored. GameID# indicates a random game code or “tag” of the game being monitored. Threshold_{—}0 indicates a point weight for attribute_{—}0, while threshold_{—}1 . . . threshold_N indicate a point weight from attribute_{—}1 to attribute_N.

An example of a rule set may be “h12.exe”, 4, 40, 2, 6, 7, 10 . . . . This means that for a game named “h12.exe” with a GameID#4, the threshold limit for attribute_{—}0 is 40, the threshold limit for attribute_{—}1 is 2 and so on. Each attribute is mapped to a function that has knowledge of how to determine if the attribute is good or bad for a particular cycle. For example, in Windows® environment, a WindowZorder attribute is used to indicate a program is in the Windows® foreground. The WindowZorder attribute is mapped to a function named “calWindowZorderWin32”, which returns true if the attribute's threshold point score should be added to the total point score, or false if the attribute's threshold point score should not be added. The total point score is a predefined or static point score that any game must reach in order to consider the user as “active”. If the “calWindowZorderWin32” function returns false, the user is considered “inactive”. However, if no user input is detected in validate entropy 710, the user is considered “idle”. In an illustrative embodiment, the “inactive” status takes precedent over the “idle” status.

Based on the rule set and validate entropy 710, agent 708 determines whether the user is active, idle, or inactive. Agent 708 then sets a game state 718 and updates client game data 720. The above use cases repeat until the collected game data reaches a predetermined threshold limit, whereas the agent either sends the updates if the client is online, or continues to accumulate client game data if user is offline. Once updates are sent, agent 708 resets the local client time data 732 and the Web server resets the client time data on Web server 734. If the agent requests specific dynamic statistical data 730, the database server 728 will send it to the local client. Furthermore, gamer 700 may request update user credits 736. In this case, provided by the aspects of the present invention, the agent will send current accumulated local client game data to Web server 734 and request a current account balance be displayed to gamer 700.

With the aspects of the present invention, gamer 700 may change agent configuration 722, for example, change functionality or options available to gamer 700. Gamer 700 may also define which games the agent is capable of monitoring by updating game list 724. When agent configuration 722 or the game list 724 is modified, the agent functionality is also updated (update agent process 726), which may affect the data sent to the database server 728. Furthermore, agent 708 manages chat functions 738 when gamer 700 requests chat 740. The chat functions include process chat message 742 with chat server 744, such as chat server 326 in FIG. 3, and process external chat 746 by communicating with external chat servers via chat gateway 748.

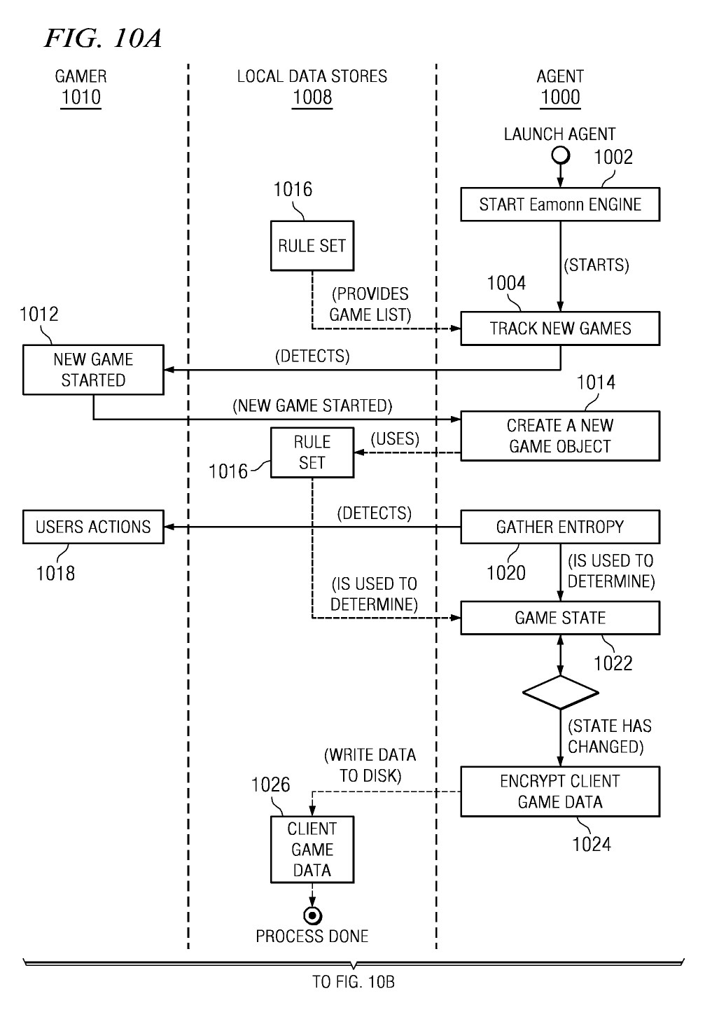

Turning now to FIGS. 8A-8B, activity diagrams illustrating activities performed by a gamer, a software agent, a server, and a chat server are depicted in accordance with an illustrative embodiment of the present invention. The activities in FIGS. 8A and 8B reflect activities that are involved when performing use cases as described in FIG. 7 above. As shown in FIG. 8A, gamer 800 first launches software agent 804, client/agent 802 verifies the connectivity 806 to determine whether gamer 800 is connected to server 808. If gamer 800 is connected to server 808, gamer 800 logs in 812 to server 808. However, if gamer 800 is not connected to server 808, a prompt is displayed 814 asking gamer 800 whether to continue logging in. After gamer 800 logs in, client/agent 802 verifies the credentials 816 of gamer 800, locally if they are offline, or remotely if they are online.

After gamer 800 logs in, gamer 800 may select start game 818. Responsive to receiving the selection, client/agent 802 executes launch Game.exe 820 to initiate the game and monitor gaming characteristics. Activities 818 and 820 are involved when performing use case launch game 701 in FIG. 7. As gamer 800 performs gaming activities 822, client/agent 802 tracks various processes 824, including CPU utilization, memory usage and the like, and performs validate entropy 826 from user inputs. More details regarding activities 824 and 826 are discussed in FIGS. 9A and 9B. A determination is then made by client/agent 802 as to whether gamer 800 is active, inactive, or idle based on the tracked processes and validated entropy. In turn, client/agent 802 sets game state 828 reflecting whether gamer 800 is active, inactive, or idle. Once the game state is set, client/agent 802 updates client game data 830. Activities 824, 826, 828, and 830 are involved when performing use cases 710, 712-716, 718, and 720 in FIG. 7 respectively.

When online, gamer 800 may manually trigger client/agent 802 to send a request credit update 832 to their personal account. Upon receiving the request, client/agent 802 sends credit update 834 to server 808, which processes credit update 838 by updating a database. After the credit update is processed, server 808 sends a successful credit update message to client/agent 802, who can display the receive credit update 836 locally. Activities 832, 834, 836, and 838 are involved when performing update user credits use case 736 in FIG. 7.

Turning now to FIG. 8B, if gamer 800 is connected to server 808, gamer 800 may request an update of game list 840. The user performs the update of the game list through a Web browser in the user's online profile. Once the game list is updated, server 808 updates supported game list 846 that is stored in server 808 and sends the updated game list file to client/agent 802, which stores the updated game list file locally 844. Activities 840, 844, and 846, are involved when performing update game list 724 use case and update agent process 726 in FIG. 7.

After gamer 800 requests to synchronize agent 848 with server 808, server 808 receives synchronize request 850 and sends static data 852 to client/agent 802, who receives static data 854. Static data may include a rule set, a game list, and other configuration files. In addition to requesting static data, client/agent 802 may also request dynamic data 856 from server 808. Dynamic data includes streaming statistics, chat buddy list, buddy status, local user status, and real time performance statistics. Upon receiving the request for dynamic data, server 808 sends dynamic data 858 to client/agent 802, which receives dynamic data 860. Activities 856-860 are involved when performing send dynamic data 730 use case in FIG. 7.

In addition to the above, client/agent 802 also facilitates chat activities. If gamer 800 logs in for chat (chat login) 862, client/agent 802 requests a new password 864 from server 808. Server 808 assigns new password request 866 to client/agent 802. After client/agent 802 receives the new password 868 from server 808, the new password is sent to chat server 810 as if the password is typed in by client/agent 802. This password is referred to as a current chat password of client/agent 802. Chat server 810 in turn validates the new password 870 and notifies client/agent 802 that a chat is ready 872. Subsequently, client/agent 802 manages various chat functions 874 while chat server 810 processes chat 876. Activities 862-876 are involved when performing use cases 738-742 in FIG. 7.

At any time, if gamer 800 wants to change configuration 878 of client/agent 802, gamer 800 may modify some configuration options locally, for example, an agent skin file. Local config options 880 can be changed regardless of network connection status and do not require access to the user's online profile. Most configuration options of client/agent 802 are accessed through the gamer's online profile. When a change occurs, server 808 then processes configuration update 882 and stores configuration changes 884. Activities 878-884 are involved when performing change agent configuration 722 use case and update agent process 726 use case in FIG. 7.

Turning now to FIG. 9, a flowchart of a process for determining a game state is depicted in accordance with an illustrative embodiment of the present invention. This exemplary process may be implemented in a software agent, such as software agent 301 in FIG. 3. As shown in FIG. 9, from the perspective of the software agent, the process begins when the software agent takes a snapshot of the operating system of the users' system (step 900). The software agent may perform this step periodically during user game play, for example, every minute, and the snapshot may be saved in user's system memory.

Next, the software agent obtains a rule set for a set of categories (step 902). These categories include processor usage, memory usage, network connectivity, window Z order, and other user inputs. A rule set defines a threshold limit for each category that is being monitored by the functions. From the snapshot of the operating system, the software agent then retrieves an individual point score that is assigned to the next category in the set of categories (step 904). For each category, an individual point score is assigned, for example, processor usage may be assigned a point score of 40 and window Z order may be assigned a point score of 35.

The software agent then makes a determination as to whether the individual point score reaches the threshold limit as defined for each category (step 906). If the individual point score reaches the threshold limit, the individual point score is added to the current cumulative total (step 908). However, if the individual point score does not reach the threshold limit, the process continues to step 914.

After step 908, software agent then makes a determination as to whether the current cumulative total is greater than or equal to the predefined total point score for an active state (step 910). The total point score is a predefined or static point score that any game must reach in order to consider the user as “active”. If the current cumulative total is greater than or equal to the predefined total point score for an active state, the software agent sets the game state to “active” (step 912) and the process terminates thereafter. “Active” state means that the user is actively engaged in game playing. If the current cumulative total is not greater than or equal to the predefined total point score for an active state, the process continues to step 914.

At step 914, a determination is made by the software agent as to whether additional categories are present in the set of categories. If so, the process returns to step 904 to retrieve the next category from the set of categories. Otherwise, a determination is made by the software agent as to whether the user's active window is in the foreground (step 916). This step is performed by examining the snapshot of the operating system. If the active window is in the foreground, the software agent sets the game state to “idle” (step 918). An example of an “idle” status is when a user completes a level, there may be a clip shown for a number of minutes. Thus, while the processor and memory may be active during the number of minutes, there may be no movement made by the user. If the active window is not in the foreground, the software agent set the game state to “inactive” (step 920). “Inactive” state means that the user is not currently engaged in game playing. Thus, the process terminates thereafter.

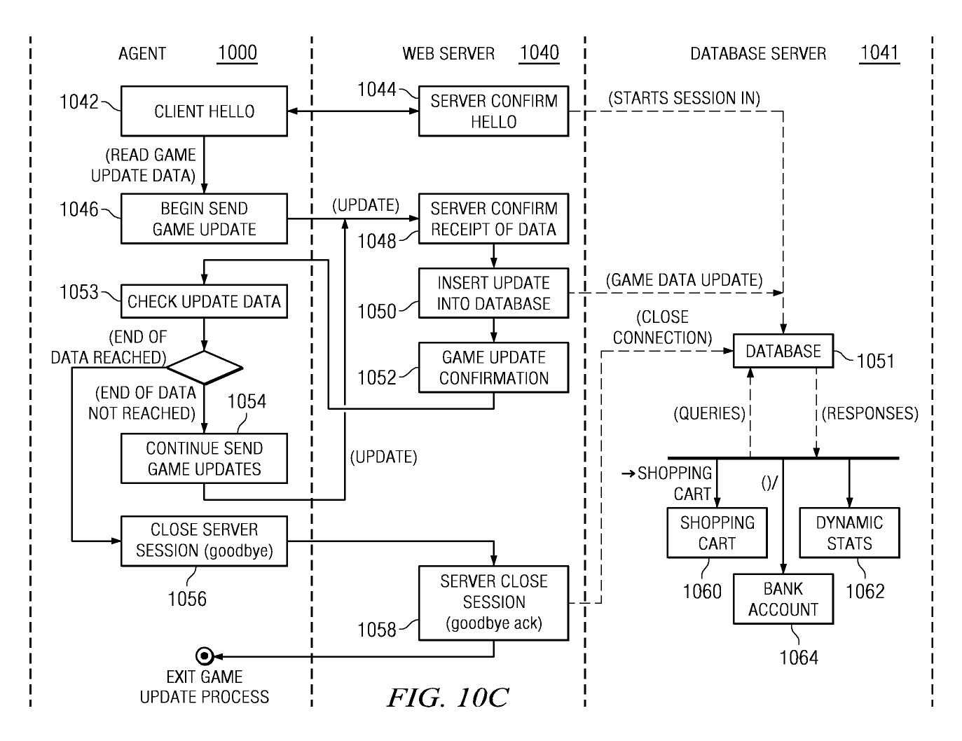

Turning now to FIGS. 10A-10C, diagrams illustrating activities and data involved when validating, storing, and transporting user game play data are depicted in accordance with an illustrative embodiment of the present invention. FIG. 10A illustrates data flow and validation of user game play data on the local client.

As shown in FIG. 10A, the process begins when agent 1000 is launched. Launch of agent 1000 starts Eamonn engine 1002. Eamonn engine 1002 starts track new games 1004 functionality, which pulls user-specific game list from rule set file 1016 that is stored in local data store 1008. The user-specific game list is created and modified as users update their game list in their online profile. When the game list is modified, agent 1000 must be synchronized to support this new information. Synchronized agent activity 848 as described in FIG. 8B dynamically updates the local rule set file as necessary.

Track new games 1004 detects that a new game has been started 1012 by gamer 1010. If a new game is started, agent 1000 creates new game object 1014 by using predefined algorithms and artificial intelligence in rule set file 1016 to provide part of the required validation of game state 1022. The remaining validation comes from gather entropy 1020 performed by agent 1000. Gather entropy 1020 detects user actions 1018 while gamer 1010 is playing the game. These actions include keyboard movement, joystick movement, mouse movement, and the like. The combination of gather entropy 1020 and rule set 1016 parameters determines game state 1022. At any time, if game state 1022 changes, agent 1000 encrypts client game data 1024 and saves the data to client game data file 1026. This validation process repeats until the user game data reaches a predetermined threshold or limit.

While client game data 1026 is accumulating, agent 1000 performs a separate process that determines how and when client game data 1026 is transferred to the server. This process is known as transport local data 1030 as shown in FIG. 10B. In FIG. 10B, transport local data 1030 may be activated manually 1028 by gamer 1010 to update credits or will be automatically activated at regular intervals. Agent 1000 first gets the network status 1032. If process is activated manually and gamer 1010 is offline, agent 1000 sends a message alerting gamer 1010 that an Internet connection is needed in order to update account credits in the personal account and then the process exits. If transport local data 1030 was activated automatically by the agent, and gamer 1010 is offline, agent 1000 exits the process without a message. However, if gamer 1010 is online, agent 1000 checks client game data threshold 1034 and determines whether the threshold has been reached. If the threshold has been reached, agent 1000 sends server updates 1036 to the server at a measured and controlled size and frequency. Transport local data 1030 is repeated if more updates are available in client game data 1026. However, if the threshold has not been reached, agent 1000 exits the process.

FIG. 10C illustrates data flow and validation of user game play data on the server. This process assumes that a client or an agent is ready to send client game data updates. This process begins when client hello 1042 is sent to Web server 1040 and the server confirms hello 1044 is received by agent 1000. In an illustrative embodiment, Web server 1040 and agent 1000 communicate with each other using a secure communication protocol, such as SOAP over HTTPS.

Agent 1000 then begins sending game updates 1046 to Web server 1040. Web server 1040 then confirms the receipt of client game data 1048 and inserts updated data 1050 into database 1051 of database server 1041. After database server 1051 of database server 1041 is updated, a game update confirmation 1052 is returned to agent 1000. Agent 1000 continues to check update data 1053 and send game updates 1054 to Web server 1040 until all updated client game data 1048 in the client game data file is sent. Once all the game data is sent, agent 1000 closes server session 1056 by sending a goodbye message to Web server 1040. Web server 1040 in turn closes session 1058, which includes closing the connection with database server 1051 of database server 1041, sends a goodbye message to agent 1000, and exits the process.

As discussed above, the data in database server 1051 may be used for various business functions, which include sending dynamic statistics 1062 to agent 1000, managing gamers' bank account credits 1064, and managing spending of account credits in a virtual mall using shopping cart 1060.

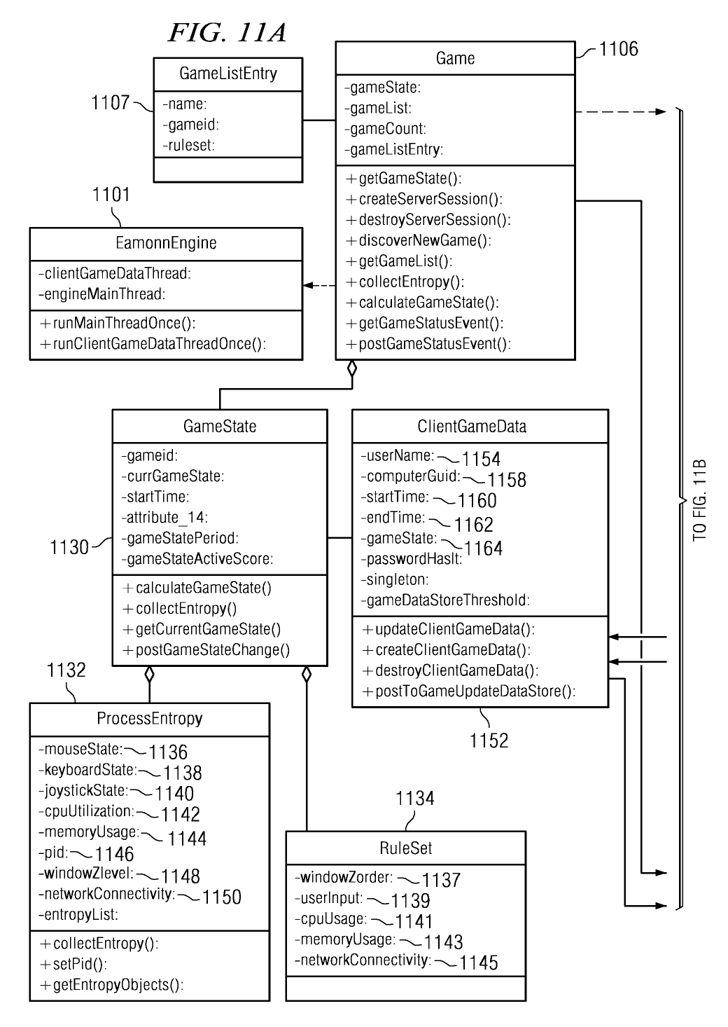

Turning now to FIGS. 11A and 11B, class diagrams illustrating exemplary classes used to implement the aspects of the present invention are depicted in accordance with an illustrative embodiment of the present invention. As shown in FIG. 11B, a gamer may launch a game via user interface 1124 by invoking launchGame 1118 function, invoke a chat using invokeChat 1114 function of chat 1108, and view a list of buddies by invoking viewBuddies 1110 function of chat 1108. In addition, gamer may update any options available to them in user interface 1124. When the gamer synchronizes with the software agent, updates to static content 1170 or dynamic content 1172 will be requested by the software agent and then sent by the Web server, such as Web server 1040 in FIG. 10C.

Eamonn user class 1100 holds user information, such as userName 1102 and password 1104. When the software agent is launched, Eamonn engine 1101 is started to track new games, process entropy, determine game state, transport local data, and the like. Eamonn engine 1101 tracks new games based on a predefined list of supported games. This list contains the game name, id, and ruleset 1134. Upon detecting that a new game is started by a gamer, Eamonn engine 1101 creates a game object 1106 as shown in FIG. 11A if the game started is in the list. In FIG. 11A, game object 1106 includes a game state 1130, which indicates whether the gamer is active, idle, or inactive. When the software agent detects user actions initiated by the gamer, process entropy 1132 obtains gaming characteristic data, such as mouse movement, keyboard movement, joystick movement, CPU utilization, memory usage, network connectivity and the like. Process entropy 1132 monitors mouseState 1136, keyboardState 1138, joystickState 1140, as well as cpuUtilization 1142, memoryUsage 1144, pid 1146, windowZlevel 1148, networkConnectivity 1150 and the like. In addition to process entropy 1132, ruleset 1134 is also used by Eamonn engine 1101 to determine a game state. Ruleset 1134 defines threshold for each attribute that is being monitored, for example, windowZorder 1137, userInputs 1139, cpuUsage 1141, memoryusage 1143, and networkConnectivity 1145.

If Eamonn engine 1101 determines that there has been a state change, it collects client game data 1152, which includes userName 1154, computerGuid 1158, startTime, 1160, endTime 1162, and gameState 1164. However, Eamonn engine 1101 may collect other client game data, such as kills, points, level, mission completion, status, and wins. Once client game data 1152 is accumulated, Eamonn engine 1101 sends the data to a server via a secure communication protocol, for example, gSoap 1174 in FIG. 11B, if a network connection is available at a predefined frequency or if a threshold limit is met. The server in turn updates the data into database 1176 in FIG. 11B via an Internet connection.

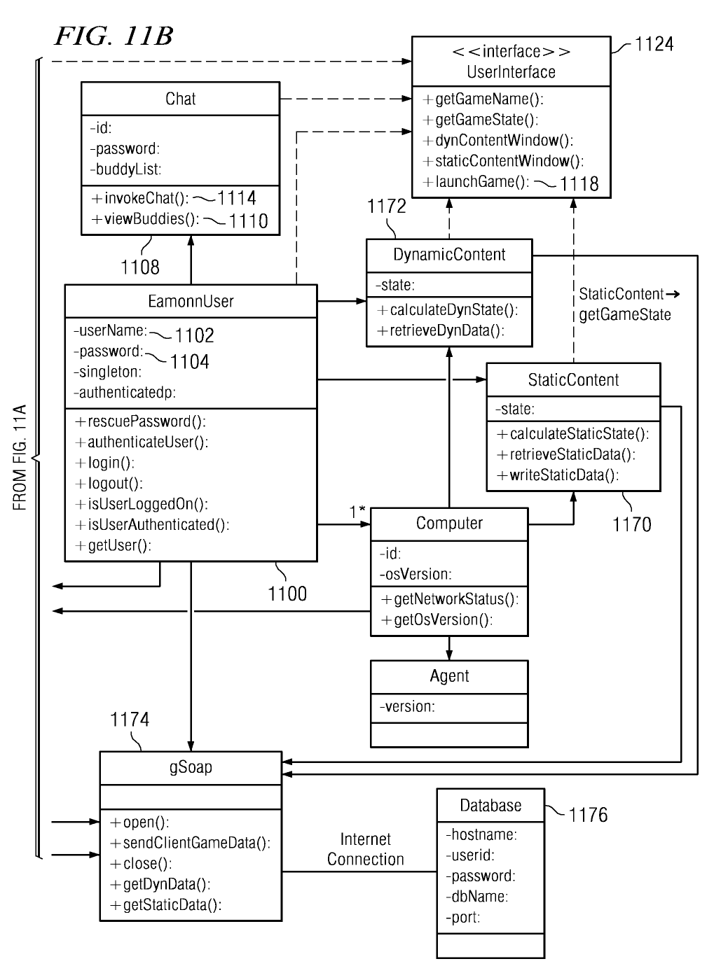

Turning now to FIGS. 12A and 12B, activity diagrams illustrating chat functionality depicted in accordance with an illustrative embodiment of the present invention. As shown in FIG. 12A, agent checks user preferences to determine whether to sign into a chat at startup. If user preferences indicate to sign into a chat at startup, agent requests chat password 1200 from Web server. Otherwise, the chat client remains idle 1202 and the user manually logs into the Web server and requests chat password 1200.

The Web server sends chat password 1204 to the agent and the client accepts password 1206. After the agent receives the new password from the Web server, the agent sends the new password to the chat server for authentication 1208 as if the password is typed in by the client. This password is referred to as a current chat password of the client. Chat server authenticates the user by validating new password 1210. If authentication is successful, a handshake is complete 1212 between the agent and the chat server. The agent may log off 1214 the chat server and exits the chat or selecting a chat function. However, if authentication is not successful, error message 1216 is returned to the user and a retry may occur.

Aspects of the present invention provide a plurality of chat functions. As shown in FIG. 12B, these chat functions include joining group chat 1218, starting group chat 1220, blocking another user 1222, removing a buddy from subscription 1224, accepting a new subscription request 1226 from another user, adding another user to subscription 1228, sending a message to another user 1230, and receiving messages 1232 from another user.

If the user receives a message 1232 from another user, the agent determines whether the other user is blocked, on the roster, or not on a roster. If the user is blocked, the message is dropped 1234. If the user is on the roster, the message is displayed 1238. If the user is not on the roster, a prompt is displayed 1236 to ask whether the user wants to accept or reject message. If the user accepts the message, the message is displayed 1238. Otherwise, the message is dropped 1234.

Turning now to FIG. 13A, a flowchart of a process for collecting user game play data from a game from the perspective of a server is depicted in accordance with an illustrative embodiment of the present invention. This exemplary process may be implemented in a server, such as server 320 in FIG. 3. As shown in FIG. 13A, the process begins, from the perspective of the server, when the server detects a user update of respective game list in the user's online profile (step 1300). The server then updates the user's game list data on the server (step 1302). A request of synchronization is received from the agent (step 1304). The agent makes the synchronization request to obtain the new game list locally. The server in turn sends the game list along with dynamic libraries that are associated with the updated games in the game list to the agent (step 1306). Each game that is supported may potentially have a different dynamic library. If the agent is never synchronized, a new game list and new dynamic libraries will never be sent. Later, the server detects a communication request from the software agent (step 1308). The server receives client game data updates from the agent with support for specific games on the updated game list (step 1310).

The server can then credit the personal account of the user with credits based on performance incentives (step 1312), such as the total points scored, in addition to credits that are given based on cumulative real time game play data, such as an amount of time the user spent playing the game. The server can then send an account update to the software agent either by user request or for dynamic statistics (step 1314), such that the user may view the status of the account. Thus, the process terminates thereafter.

Turning now to FIG. 13B, a flowchart of a process for collecting user game play data from a game from the perspective of a software agent is depicted in accordance with an illustrative embodiment of the present invention. This exemplary process may be implemented in a software agent, such as software agent 301 in FIG. 3. As shown in FIG. 13B, the process begins when the software agent detects that the user is starting a new game (step 1320). Next, the software agent loads a corresponding dynamic library and a game variable list for the game into memory (step 1322). The game variable list includes variables that the game constantly monitors. This list may be supplied by the game developers.

After loading the variables into memory, the software agent uses the game variable list to load additional functions into memory (step 1324). Each game variable has a corresponding function in the dynamic library that can calculate the variable. An example of a game variable and corresponding function is WindowZorder and “calWindowZorderWin32” as discussed above.

At a set interval, the software agent calls the corresponding function to store the data that is collected by the function (step 1326). The data may be encrypted and stored in a client game data file or in a separate file. If a network connection is available, and the threshold is reached, the software agent sends the client game data to the server (step 1328), which includes data that is collected by the function. Thus, the process terminates thereafter.

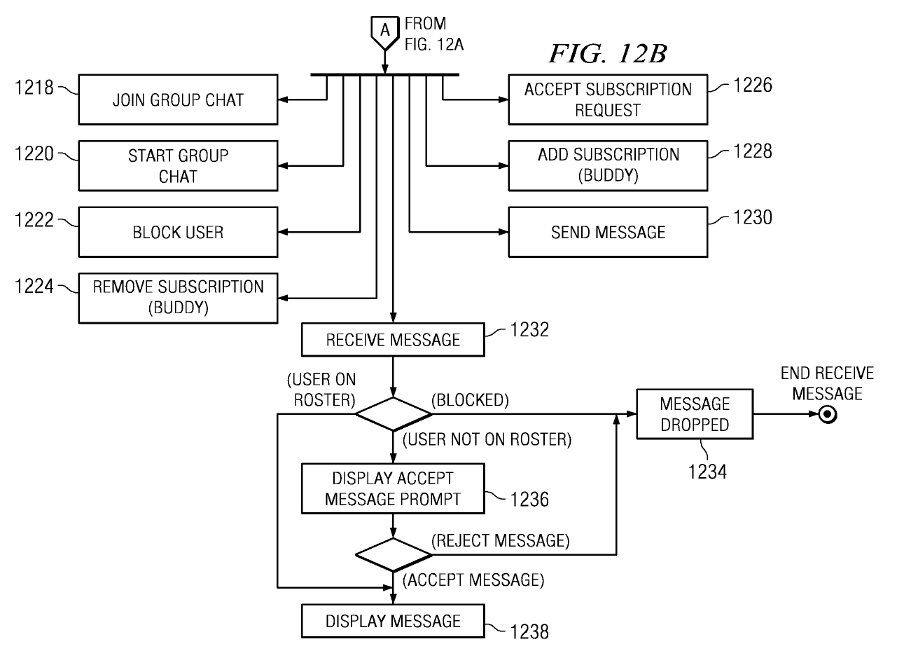

FIG. 14 is a flowchart of a process for configuring a software agent to operate in an online environment in accordance with an illustrative embodiment of the present invention. This exemplary process may be implemented using a software agent, such as software agent 301 in FIG. 3, located on or executed on a data processing system, including a client data processing system, a server data processing system, or a combination of client data processing systems and server data processing systems. Examples of client data processing systems include clients 110, 112, and 114 in FIG. 1, and a client can also be a local data processing system. Examples of server data processing systems include servers 104 and 106 in FIG. 1. The illustrative examples described herein can also be implemented on other data processing systems, such as but not limited to personal digital assistants (PDAs), cell phones, laptop computers, and other data processing systems. In an illustrative example, a local data processing system is a data processing system operated by an end user of an online game.

As used herein, a game server is a data processing system on which the software agent or a plug-in associated with the software agent can be loaded. In a non-limiting illustrative embodiment, only the plug-in associated with the software agent is loaded on the game server and the software agent itself is loaded on the local data processing system.

In an illustrative embodiment, a remote game server is a game server that is a remote server or a remote data processing system, with a remote game server also being referred to as an online gaming server. A remote server is any server that is distinct from a local data processing system and that is located in a different geographical location from the local data processing system.

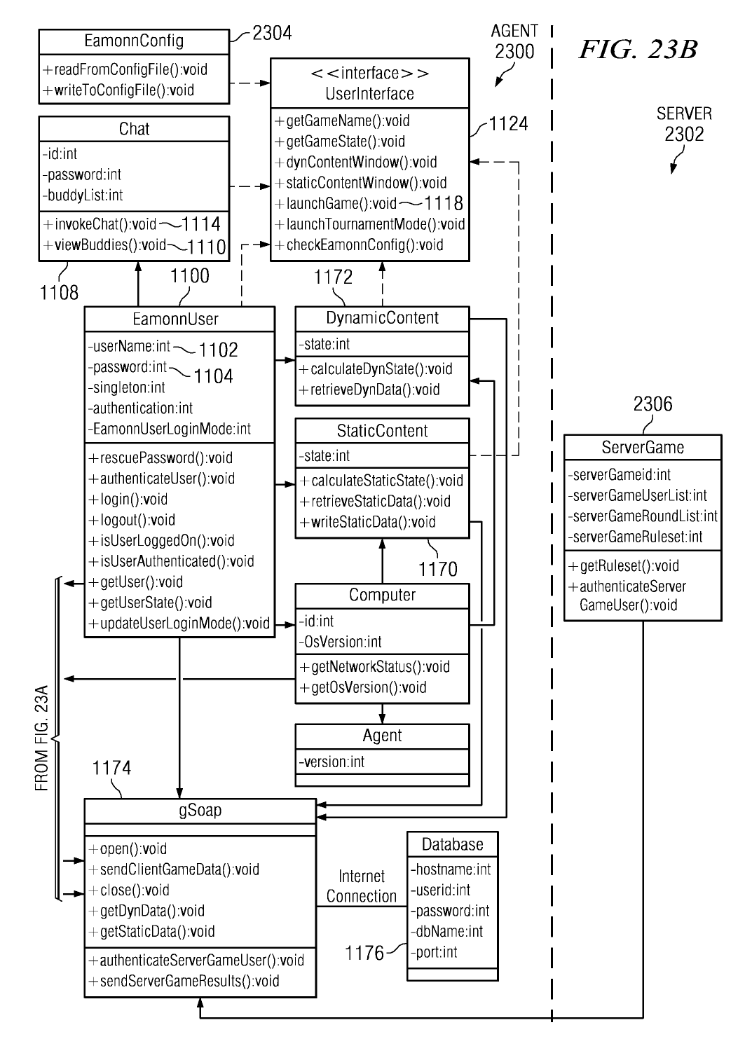

However, in another illustrative embodiment, a game server can also be a local game server. A local game server can be a server of a local area network, or can be a software construct executed by an operating system on a single local computer. In this illustrative example, the local computer hosts both the software agent, such as agent 2300 in FIG. 23A, and the associated plug-in component, such as plug-in component server game 2306 in FIG. 23B.

Thus, a server session can be executed on the same data processing system that is executing a local session. In this case, the software agent and the associate plug-in still operates in the same manner as in the case where the local session is executed on a local data processing system and the server session is executed on a remote data processing system or remote game server.

The process begins as the software agent, such as agent 1000 in FIG. 10A through FIG. 10C, receives game information (step 1400). Game information can be entered by a user through a user interface, such as UserInterface 1124 in FIG. 11B, from which the software agent can receive the game information. Game information can also be received from a remote game server which is used in conjunction with running an online game. Game information can include the name of the game to be played, properties of the game used by the software agent, connection information, and other game information.

The software agent then updates the configuration file of the software agent, such as an EamonnConfig file of Eamonn engine 1002 in FIG. 10A (step 1402). In this way, the software agent is able to operate with the game to be played. The process terminates thereafter.

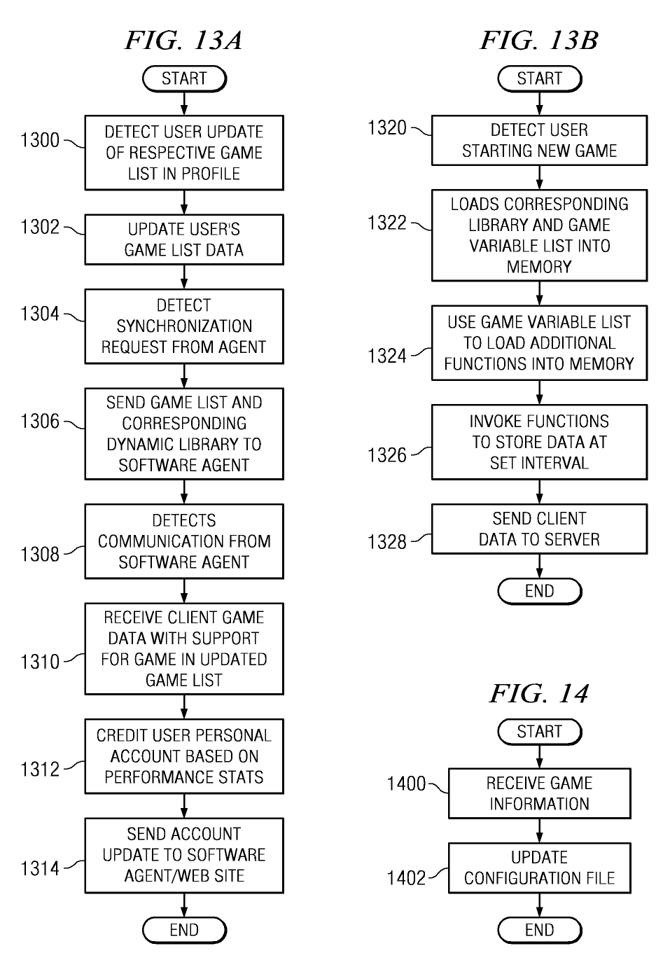

FIG. 15 is a flowchart of a process of entering tournament mode of a software agent to operate in an online environment, in accordance with an illustrative embodiment of the present invention. This exemplary process may be implemented using a software agent, such as software agent 301 in FIG. 3, located on or executed on a data processing system, including a client data processing system, a server data processing system, or a combination of client data processing systems and server data processing systems. Examples of client data processing systems include clients 110, 112, and 114 in FIG. 1, and a client can also be a local data processing system. Examples of server data processing systems include servers 104 and 106 in FIG. 1. The illustrative examples described herein can also be implemented on other data processing systems, such as but not limited to personal digital assistants (PDAs), cell phones, laptop computers, and other data processing systems. In an illustrative example, a local data processing system is a data processing system operated by an end user of an online game.

As used herein, a game server is a data processing system on which the software agent or a plug-in associated with the software agent can be loaded. In a non-limiting illustrative embodiment, only the plug-in associated with the software agent is loaded on the game server and the software agent itself is loaded on the local data processing system.

In an illustrative embodiment, a remote game server is a game server that is a remote server or a remote data processing system, with a remote game server also being referred to as an online gaming server. A remote server is any server that is distinct from a local data processing system and that is located in a different geographical location from the local data processing system.

However, in another illustrative embodiment, a game server can also be a local game server. A local game server can be a server of a local area network, or can be a software construct executed by an operating system on a single local computer. In this illustrative example, the local computer hosts both the software agent, such as agent 2300 in FIG. 23A, and the associated plug-in component, such as plug-in component 2306 in FIG. 23B.

Thus, a server session can be executed on the same data processing system that is executing a local session. In this case, the software agent and the associate plug-in still operates in the same manner as in the case where the local session is executed on a local data processing system and the server session is executed on a remote data processing system or remote game server.

The process begins when the software agent begins tournament mode (step 1504). At this point, the software agent receives instructions that a game will be played in tournament mode or online mode. The software agent can receive the input that triggers tournament mode verification from a user through a user interface. The software agent can also receive the input to trigger tournament mode verification from a remote game server which is used in conjunction with running an online game.

Next, the software agent checks the configuration file (step 1506) for information regarding changes to the software agent, the process of receiving credits, or other changes in the service provided by or through the software agent. The software agent then determines whether to prompt the user to agree to a change in the service agreement (step 1508). If the user should be prompted, then the software agent displays changes to the service agreement (step 1510). Thereafter, the user is prompted whether the user agrees with the changes (step 1512). If the user does not agree to the changes, the process terminates; otherwise, the process continues at step 1514.

In an illustrative embodiment, the service agreement is an agreement to pool credits that the winner of the tournament or only specified parties will receive credits earned by the user. The service agreement can also be a service agreement relating to the online game or to the provider of the software agent. In an illustrative embodiment, a user may check a selection for “don't show me this agreement again.” In this embodiment, if the selection is checked then a “yes” answer is assumed, meaning that the process can skip from step 1506 to step 1514 such that step 1508 can be skipped altogether.

Returning to step 1508, if no prompt for a change in the service agreement is determined or if the user agrees to any changes at step 1512, then the software agent again checks the configuration file (step 1514) for information related to tournament mode information. The software agent then determines whether online tournament mode information is stored locally (step 1516). If online tournament mode information is not stored locally, then the user is prompted for game information (step 1518). Game information can be the game information described above with respect to step 1400 of FIG. 14. Alternatively, the software agent can request that such game information be provided by the server that is involved with the online game. The software agent then determines whether game information has been received (step 1520). If game information has not been received, then the process terminates; otherwise, if game information has been received, the process proceeds to step 1522.

Returning to step 1516, if game information is stored, or if game information has been received at step 1520, then the software agent updates an active session table (step 1522) located in a database. The database can be stored locally on a local data processing system, on a remote game server associated with the game, or some other remote server.

The active session table stores game specific information, such as the game information described above, and also stores identity (ID) mapping information. Identity mapping information includes information that allows the software agent to map a game name to the user name. Many users maintain multiple game names. For example, one user may have three game names for a first game, two game names for a second game, and one game name each for four other games. Identity mapping information allows the software agent to map these game names to a single user name in order to associate each game name to the single user name.

The software agent then transmits a confirmation message to the user and/or to the game server associated with the game (step 1524). The software agent then initiates an active session (step 1526). The software agent engages tournament type operation (1528). As a result, the software agent changes the client data, such as ClientGameData 1152 of FIG. 11A, to tournament mode state (step 1530). Additionally, the software agent changes the manner in which credits are awarded based on the fact that tournament mode is engaged. For example, credits can be awarded to a winner of a competition, divided among the top competitors, or any other scheme. Thus, a player can, after permission, earn credits but then the software agent can transfer those credits to the winner of the game if the player loses.

Simultaneously after activating the session (step 1526), the software agent performs a session check (step 1532). The session check verifies the game connection at various intervals, which can be pre-determined or random. The software agent then determines if the session is O.K. (step 1534). The session is O.K. if a connection exists between the client computer and the game server. In another illustrative embodiment, the session is only O.K. if a connection exists and also if an active session has not been breached. Other security checks can also be added in the determination that the session is O.K. If the session is O.K., then the client repeats the session check at step 1532. If the session is not O.K. at step 1534, that is, if the session is terminated or otherwise broken, then the process terminates.

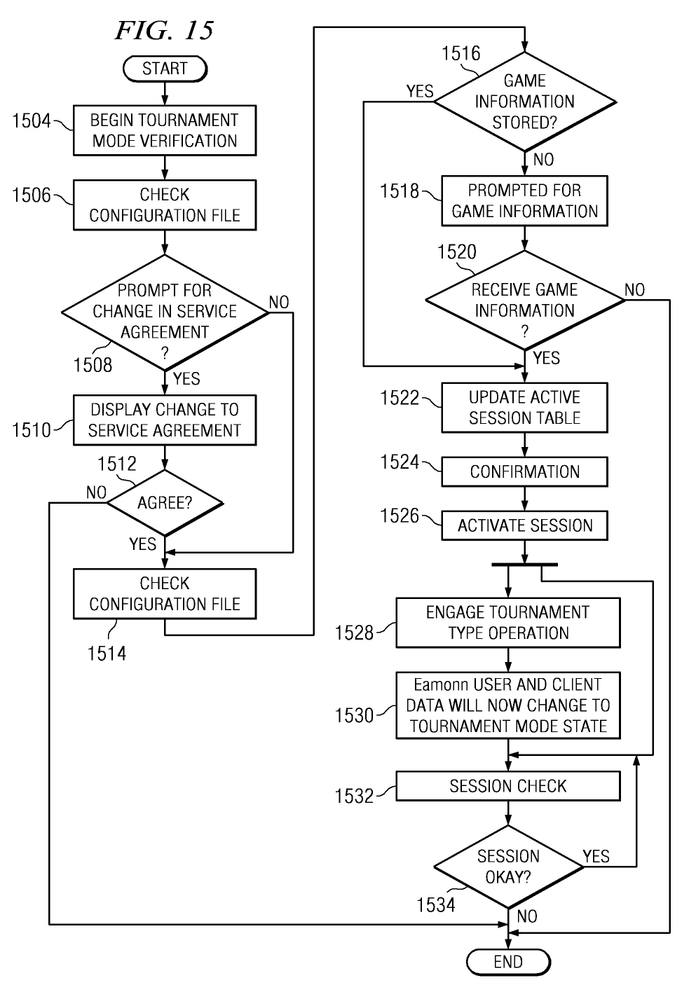

FIG. 16 is a flowchart of a process for collecting game play data in an online environment in accordance with an illustrative embodiment of the present invention. This exemplary process may be implemented using a software agent, such as software agent 301 in FIG. 3, located on or executed on a data processing system, including a client data processing system, a server data processing system, or a combination of client data processing systems and server data processing systems. Examples of client data processing systems include clients 110, 112, and 114 in FIG. 1, and a client can also be a local data processing system. Examples of server data processing systems include servers 104 and 106 in FIG. 1. The illustrative examples described herein can also be implemented on other data processing systems, such as but not limited to personal digital assistants (PDAs), cell phones, laptop computers, and other data processing systems. In an illustrative example, a local data processing system is a data processing system operated by an end user of an online game.

As used herein, a game server is a data processing system on which the software agent or a plug-in associated with the software agent can be loaded. In a non-limiting illustrative embodiment, only the plug-in associated with the software agent is loaded on the game server and the software agent itself is loaded on the local data processing system.

In an illustrative embodiment, a remote game server is a game server that is a remote server or a remote data processing system, with a remote game server also being referred to as an online gaming server. A remote server is any server that is distinct from a local data processing system and that is located in a different geographical location from the local data processing system.

However, in another illustrative embodiment, a game server can also be a local game server. A local game server can be a server of a local area network, or can be a software construct executed by an operating system on a single local computer. In this illustrative example, the local computer hosts both the software agent, such as agent 2300 in FIG. 23A, and the associated plug-in component, such as plug-in component 2306 in FIG. 23B.

Thus, a server session can be executed on the same data processing system that is executing a local session. In this case, the software agent and the associate plug-in still operates in the same manner as in the case where the local session is executed on a local data processing system and the server session is executed on a remote data processing system or remote game server.

In an illustrative embodiment, the process shown in FIG. 16 occurs after or during the process shown in FIG. 15. Thus, the software agent can be continually performing session checks, as shown in FIG. 15, while the process shown in FIG. 16 occurs. Additionally, in an illustrative embodiment, the process shown in FIG. 16 occurs on the server side of an online gaming environment. In this case, the process is implemented by plug-in software operating on the game server.

The process shown in FIG. 16 begins as the plug-in software agent validates a game connection (step 1600). A game connection is a connection between game software loaded and executed on a local client computer and a corresponding game server. Then, the plug-in software agent requests game information from the active session table (step 1602). The plug-in software agent then receives game information, which in an illustrative example is information such as password, server information, Internet protocol address, or other information. Game information can also be other types of information, as described with respect to step 1400 of FIG. 14 (step 1604). At this point the plug-in software agent determines whether the stored or received game information matches game information retrieved by the plug-in software agent regarding the aspects of the game performed by the remote game server (step 1606). If a match does not exist, then the plug-in software agent prompts the user to fix the problem (step 1608). The user can fix the problem by providing correct game information or by taking other steps to correct the mismatch in information such as, for example, updating user information provided to the remote game server.

The plug-in software agent then checks whether the plug-in software agent has received the requested game information (step 1610). If the game information has not been received, then the process terminates. Otherwise, if the game information has been received, then the plug-in software agent updates the game information with the provided game information (step 1612).

The plug-in software agent then performs a recheck between the received game information and the online game information, and determines whether the validate game connection check is successful (step 1614). If the recheck is not successful, then the user is again prompted to attempt to fix the problem at step 1608. If the recheck is successful, then the plug-in software agent allows entrance into the game (step 1616).

During game execution, the game generates game events in response to user actions during game play (step 1618). The plug-in software agent can process the game events according to the methods and devices described in FIG. 1 through FIG. 13B to determine game play data and to generate user credits generated during game play (step 1620). The plug-in software agent also transmits user credits to the game server or to another remote server in order to update a user bank account table (step 1622). The transmission of user credits can be to other users in a system when tournament mode is activated. For example, all or some credits earned by one user can go to the winner of a tournament, split among a winning team of users, or any other scheme for pooling or awarding user credits. Once the software agent determines the distribution, the credits are then transmitted to the appropriate user account or accounts.

In an illustrative embodiment, the game state does not necessarily have to change in tournament mode for data to be collected. Additionally, data can be collected at specific points in the game, such as at the end of a round, number of kills reached, or at other benchmarks.

In another illustrative embodiment, a plug-in application can be loaded and operated on a local game server. A local game server is a computer configured to operate as a game server. A local game server can be a server of a local area network, or can be a software construct executed by an operating system on a single computer. In this example, the plug-in software agent monitors gaming characteristics of the user and identifies a game state based on the gaming characteristics. The plug-in application collects game play data if the game state is changed while the game is executing. The plug-in application also reports the game play data for processing to a third remote server or to some other storage device.

In use, a number of game users play together online via a remote game server. Each user's local computer or other data processing system monitors respective gaming characteristics and game state. The plug-in application on the remote game server collects the game play data of each user and reports the game play data of each user. Thus, in this illustrative embodiment, competitive users can be better assured that collection of game play data is performed in a fair way and according to the rules of the game. In other words, this illustrative embodiment helps to prevent cheating.

Returning to the process of FIG. 16, the software agent also determines whether the session is active (step 1624). The session is active if a connection exists between the local computer and the remote game server. If the session is active, then the process returns to step 1618. Game play and software agent operation continues in this case. However, if the session is not active, then the process terminates.

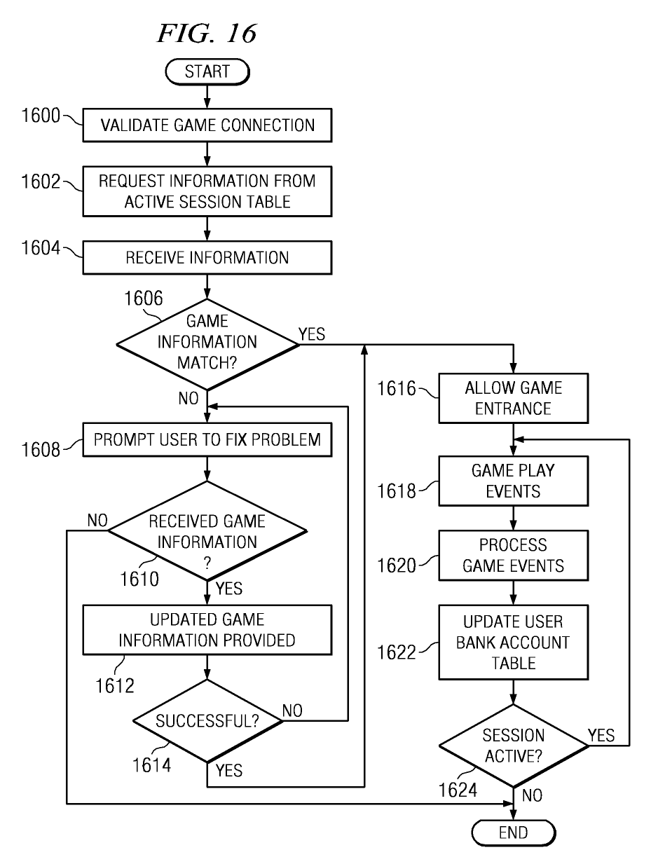

FIG. 17 is a flowchart illustrating a process of storing a prompt rule set for a challenge prompt in accordance with an illustrative embodiment of the present invention. This exemplary process may be implemented using a software agent, such as software agent 301 in FIG. 3, located on or executed on a data processing system, including a client data processing system, a server data processing system, or a combination of client data processing systems and server data processing systems. Examples of client data processing systems include clients 110, 112, and 114 in FIG. 1, and a client can also be a local data processing system. Examples of server data processing systems include servers 104 and 106 in FIG. 1. The illustrative examples described herein can also be implemented on other data processing systems, such as but not limited to personal digital assistants (PDAs), cell phones, laptop computers, and other data processing systems. In an illustrative example, a local data processing system is a data processing system operated by an end user of an online game.

As used herein, a game server is a data processing system on which the software agent or a plug-in associated with the software agent can be loaded. In a non-limiting illustrative embodiment, only the plug-in associated with the software agent is loaded on the game server and the software agent itself is loaded on the local data processing system.

In an illustrative embodiment, a remote game server is a game server that is a remote server or a remote data processing system, with a remote game server also being referred to as an online gaming server. A remote server is any server that is distinct from a local data processing system and that is located in a different geographical location from the local data processing system.

However, in another illustrative embodiment, a game server can also be a local game server. A local game server can be a server of a local area network, or can be a software construct executed by an operating system on a single local computer. In this illustrative example, the local computer hosts both the software agent, such as agent 2300 in FIG. 23A, and the associated plug-in component, such as plug-in component 2306 in FIG. 23B.

Thus, a server session can be executed on the same data processing system that is executing a local session. In this case, the software agent and the associate plug-in still operates in the same manner as in the case where the local session is executed on a local data processing system and the server session is executed on a remote data processing system or remote game server.

The process shown in FIG. 17 can be executed during the process shown in FIG. 14 through FIG. 16. For example, the process of providing a user with a challenge prompt can be performed while the user is playing a game and the software agent or a plug-in application on a remote game server are collecting game play data. The process shown in FIG. 17 can be performed in whole or part by a plug-in application loaded on a remote game server. In this case, the plug-in application communicates with the software agent and works with the software agent to accomplish the method shown in FIG. 17.

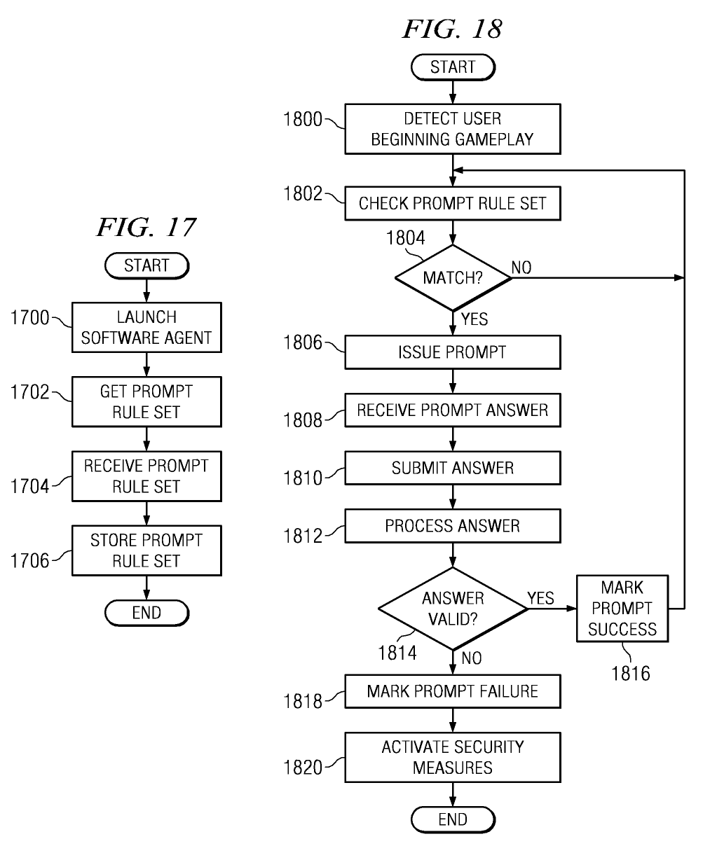

The process shown in FIG. 17 can also be executed during the processes shown in FIG. 1 through FIG. 13B, and other processes described herein. Thus, the process of storing rule sets for a challenge prompt can be performed with respect to single player game play on a single local computer, with respect to one or more players playing one or more games on a local network of computers, or with respect to a vast number of players playing one or more games online while interacting with one or more game servers. Reference to the term software agent in FIG. 17 can refer to the software agent loaded or executed on a local computer, a related plug-in application loaded or executed on a remote game server, or a combination thereof. The process shown in FIG. 17 can be performed just prior to, or as a part of, the process shown in FIG. 18, below.

The process begins as the software agent is launched (step 1700). The software agent queries a local data store to obtain a prompt rule set (step 1702). A prompt rule set describes parameters regarding prompting a user during game play. Such a prompt can be described as a challenge prompt. Parameters can include time elapsed since launch of the game, time elapsed since the last prompt, whether a repetitive action is occurring in the game, what questions should be asked at a prompt, entering a keystroke or keystroke combination as a prompt response, entering some other controller input as a prompt response, voice or audio input, and possibly numerous other rules governing the challenge prompt.

In response, the software agent receives the prompt rule set (step 1704) and then stores the prompt rule set (1706). The prompt rule set is stored such that the prompt rule set is available during execution of the game. Thus, the prompt rule set can be stored locally or on a game server.

FIG. 18 is a flowchart of a process for issuing a challenge prompt to a user during game play in accordance with an illustrative embodiment of the present invention. This exemplary process may be implemented using a software agent, such as software agent 301 in FIG. 3, located on or executed on a data processing system, including a client data processing system, a server data processing system, or a combination of client data processing systems and server data processing systems. Examples of client data processing systems include clients 110, 112, and 114 in FIG. 1, and a client can also be a local data processing system. Examples of server data processing systems include servers 104 and 106 in FIG. 1. The illustrative examples described herein can also be implemented on other data processing systems, such as but not limited to personal digital assistants (PDAs), cell phones, laptop computers, and other data processing systems. In an illustrative example, a local data processing system is a data processing system operated by an end user of an online game.

As used herein, a game server is a data processing system on which the software agent or a plug-in associated with the software agent can be loaded. In a non-limiting illustrative embodiment, only the plug-in associated with the software agent is loaded on the game server and the software agent itself is loaded on the local data processing system.

In an illustrative embodiment, a remote game server is a game server that is a remote server or a remote data processing system, with a remote game server also being referred to as an online gaming server. A remote server is any server that is distinct from a local data processing system and that is located in a different geographical location from the local data processing system.

However, in another illustrative embodiment, a game server can also be a local game server. A local game server can be a server of a local area network, or can be a software construct executed by an operating system on a single local computer. In this illustrative example, the local computer hosts both the software agent, such as agent 2300 in FIG. 23A, and the associated plug-in component, such as plug-in component 2306 in FIG. 23B.

Thus, a server session can be executed on the same data processing system that is executing a local session. In this case, the software agent and the associate plug-in still operates in the same manner as in the case where the local session is executed on a local data processing system and the server session is executed on a remote data processing system or remote game server.

The process shown in FIG. 18 can be executed during the process shown in FIG. 15. For example, the process of providing a user with a challenge prompt can be performed while the user is playing a game and the software agent or a plug-in application on a remote game server are collecting game play data. The process shown in FIG. 18 can be performed in whole or part by a plug-in application loaded on a remote game server. In this case, the plug-in application communicates with the software agent and works with the software agent to accomplish the method shown in FIG. 18.

The process shown in FIG. 18 can also be executed during the processes shown in FIG. 1 through FIG. 13B, and other processes described herein. Thus, the process of providing a challenge prompt can be performed with respect to single player game play on a single local computer, with respect to one or more players playing one or more games on a local network of computers, or with respect to a vast number of players playing one or more games online while interacting with one or more game servers. Reference to the term software agent in FIG. 18 can refer to the software agent loaded or executed on a local computer, a related plug-in application loaded or executed on a remote game server, or a combination thereof. The process shown in FIG. 18 can be executed just after or as a part of the process shown in FIG. 17.

The process begins as the software agent detects a user beginning game play (step 1800). The software agent then checks the prompt rule set (step 1802). The software agent determines if a match exists between a current condition and at least one rule in the prompt rule set (step 1804). A current condition can be actual time elapsed since launch of the game, time elapsed since a previous challenge prompt, detection of a repetitive action within the game play, a random parameter, or other conditions related to the prompt rule set. A random parameter can be any random parameter, such as but not limited to random time elapsed, a random number of times a game is launched, and others. If no match exists, then the software agent continues to check the prompt rule set at step 1802.

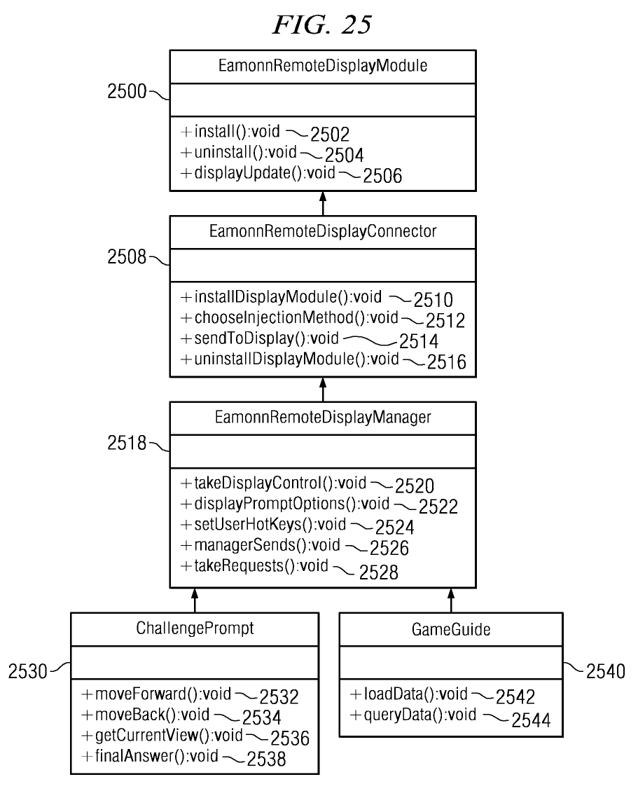

However, if a match does exist at step 1804 between a current condition and a rule in the prompt rule set, then the software agent issues a prompt to the user during game play (step 1806). The prompt can appear in a dynamic window that appears within the game or outside of the game such that the user can understand the prompt. A dynamic window is a window that appears within a game, but is contained or owned by a process external to the game. In particular, the software agent controls the dynamic window and what appears in the dynamic window. A dynamic window can be implemented using class objects, such as those shown in FIG. 25. The term “outside of the game” or “outside of game play” means that the game is running in the background and the dynamic window is presented outside the game. The term “within the game” or “during game play” means that the dynamic window appears while the game is still being played, and may include code that acts through or with or a part of the game code.

The challenge prompt may take the form of a question or an instruction, and can appear as text, an icon, or a combination thereof, that appears in a form that disrupts game play as little as possible, though the user should be able to recognize the prompt and understand how to respond to the prompt. For example, a challenge prompt question may ask a user, “What number precedes 32?” The correct answer, which can be quickly and easily supplied by a user, is “31”. In another example, a challenge prompt instruction may direct a user to type a simple string of text, such as, “Please type the word ‘game,” or require the user to click on a particular icon presented in the dynamic window. If desired, the challenge prompt can interrupt game play. If desired, additional information can be elicited from the user, such as answers to a questionnaire or review about the game.

In an illustrative example, the software agent can pre-select the answer to the challenge prompt question before issuing the prompt. The actual answer is not presented to the user and is not compared to the rule set. Instead, the answer is noted as the stop point in the selection choice and then compared to the stored answer in the software agent.

In an illustrative example, the user is prompted without interruption of game play. Thus, the challenge prompt does not interfere with mouse, keyboard, joystick, or game controller functions. The user is notified that the user must answer the challenge prompt within a certain time or face “failing” the prompt. After being notified, an active user can quickly and easily use the keyboard, mouse, game controller, or other input/output device to enable the challenge question window, quickly choose a correct answer and continue the game and approved credit accumulation. The challenge prompt thereby eliminates robotic devices, programmable hardware, software automation tools, and other techniques for cheating that cannot be stopped through software intelligence alone.

The software agent then receives the prompt answer (step 1808). A prompt answer can be in the form of a text response, a keystroke combination, a mouse click, input of a game controller, voice or audio response, a light from a pointer or game controller, or any desired response. After receiving the prompt answer, the software agent submits the answer to a software object (step 1810), which can be part of the software agent. The software object processes the answer, answers, response, or responses (step 1812) by comparing the answer to the stored answer.

The software agent or the software object then determines if the answer is valid (step 1814). If the answer is valid, then the prompt is marked as successful (step 1816) and the process returns to step 1802 for continued processing. In addition, the processing of user credits generated while playing the game is permitted. However, an answer also might not be valid. An invalid answer is an incorrect answer. An invalid answer also occurs in the case that the software agent or software object fails to receive an answer within a predefined period of time. The predefined period of time can be a quantity of time, such as a period of thirty (30) minutes. In this manner, a user playing a game is not required to immediately interrupt game play in order to provide a response to the challenge prompt. Instead, a user can provide the answer at the most opportune time, such as at the end of a match or at any other lull in the game play action. If the answer is not valid at step 1814, then the failure to respond to the prompt correctly is marked for additional processing (step 1818). The term “marked” means that a data packet indicating the failure is generated or some other data packet is otherwise modified to indicate the failure. Thus, an illustrative method provides for, responsive to an event selected from the group consisting of an incorrect response to the challenge prompt and failure to respond to the challenge prompt, marking a challenge failure.

At that point, the software agent activates security measures (step 1820). The security measures can be to suspend one or more of the software agent's functions, including collection of game data, accumulation of user credits, or other software agent functions. The security measures can also be to generate a second challenge prompt before suspending one or more operations of the software agents. Additional challenge prompt failures can be required before suspension of software agent functions. Other security measures include suspension of game play or termination of the game, such as when the user is beta testing a game and the user is required to allow the software agent to collect game data while playing the game, or when the user is in an environment which prohibits cheating (such as an online gaming environment). If desired, the security measures can be to mark data packets generated after security measures are activated and continue game play and software agent functions normally. In any case, after the software agent activates security measures, the process terminates. The process can also terminate at any time during the process shown in FIG. 18 if security is breached or if the active session ends or becomes corrupted. In this way, the illustrative method described above provides for activating a security measure in response to the challenge failure. In one embodiment, the security measure is selected from the group consisting of suspending at least one function of the software agent, generating a second challenge prompt, suspending game play, terminating execution of the game, and marking data packets generated after the challenge failure.

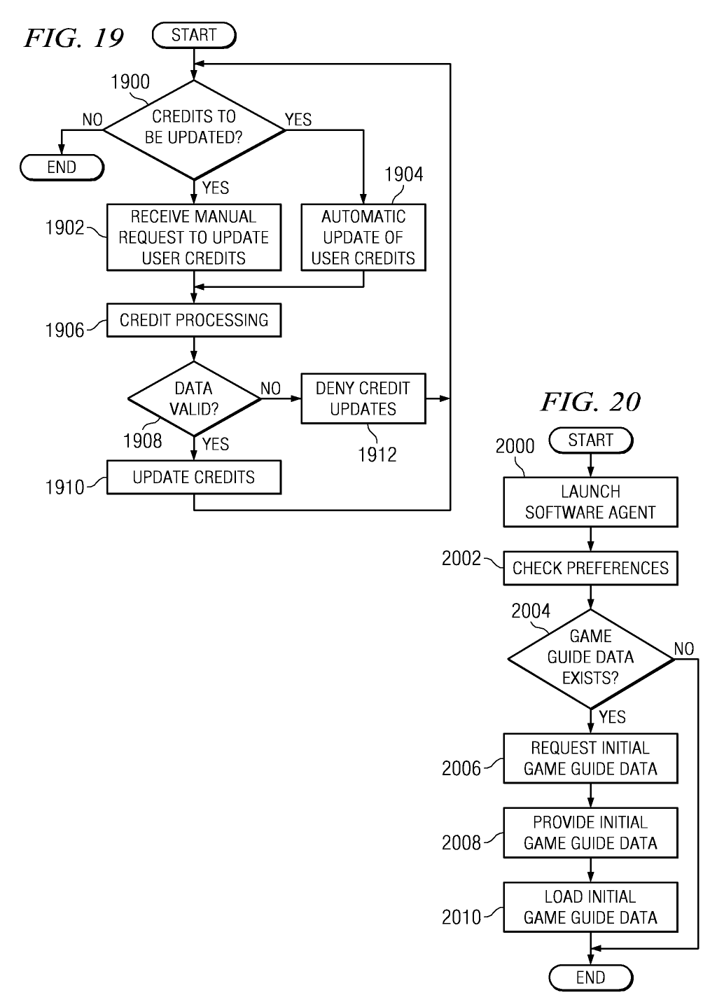

FIG. 19 is a flowchart of a process for crediting a user with account credits as a result of game play in an online environment in accordance with an illustrative embodiment of the present invention. This exemplary process may be implemented using a software agent, such as software agent 301 in FIG. 3, located on or executed on a data processing system, including a client data processing system, a server data processing system, or a combination of client data processing systems and server data processing systems. Examples of client data processing systems include clients 110, 112, and 114 in FIG. 1, and a client can also be a local data processing system. Examples of server data processing systems include servers 104 and 106 in FIG. 1. The illustrative examples described herein can also be implemented on other data processing systems, such as but not limited to personal digital assistants (PDAs), cell phones, laptop computers, and other data processing systems. In an illustrative example, a local data processing system is a data processing system operated by an end user of an online game.

As used herein, a game server is a data processing system on which the software agent or a plug-in associated with the software agent can be loaded. In a non-limiting illustrative embodiment, only the plug-in associated with the software agent is loaded on the game server and the software agent itself is loaded on the local data processing system.

In an illustrative embodiment, a remote game server is a game server that is a remote server or a remote data processing system, with a remote game server also being referred to as an online gaming server. A remote server is any server that is distinct from a local data processing system and that is located in a different geographical location from the local data processing system.

However, in another illustrative embodiment, a game server can also be a local game server. A local game server can be a server of a local area network, or can be a software construct executed by an operating system on a single local computer. In this illustrative example, the local computer hosts both the software agent, such as agent 2300 in FIG. 23A, and the associated plug-in component, such as plug-in component 2306 in FIG. 23B.

Thus, a server session can be executed on the same data processing system that is executing a local session. In this case, the software agent and the associate plug-in still operates in the same manner as in the case where the local session is executed on a local data processing system and the server session is executed on a remote data processing system or remote game server.

The process shown in FIG. 19 can be executed during the process shown in FIG. 15. For example, the process of providing a user with user credits can be performed while the user is playing a game and the software agent or a plug-in application on a remote game server are collecting game play data. The process shown in FIG. 19 can be performed in whole or part by a plug-in application loaded on a remote game server. In this case, the plug-in application communicates with the software agent and works with the software agent to accomplish the method shown in FIG. 19. Reference to the term software agent in FIG. 19 can refer to the software agent loaded or executed on a local computer, a related plug-in application loaded or executed on a remote game server, or a combination thereof.

The process shown in FIG. 19 can also be executed during the processes shown in FIG. 1 through FIG. 13B, and other processes described herein. Thus, the process of providing a user with user credits can be performed with respect to single player game play on a single local computer, with respect to one or more players playing one or more games on a local network of computers, or with respect to a vast number of players playing one or more games online while interacting with one or more game servers. Reference to the term software agent in FIG. 19 can refer to the software agent loaded or executed on a local computer, a related plug-in application loaded or executed on a remote game server, or a combination thereof.

The process begins as the software agent determines whether user credits are to be updated (step 1900). As described with respect to FIG. 7, FIGS. 8A-8B, and FIG. 13A, and elsewhere, user credits are points awarded to players according to a variety of parameters, including time of game play, performance within the game, which games are played, or other parameters. If user credits are to be updated, then the software agent optionally receives a manual request to update user credits (step 1902). A manual request to update user credits is a request by a user to update user credits. Simultaneously, the software agent optionally automatically updates user credits (step 1904). Although the update of user credits can be initiated automatically, in step 1904, or through receipt of a manual request, in step 1902, at least one of steps 1902 and 1904 occur in this illustrative embodiment.

Whether a manual request to update user credits is received or an automatic update of user credits is initiated, the software agent performs credit processing (step 1906). Credit processing of user credits can be performed according to the methods described with respect to FIG. 7, FIGS. 8A-8B, and FIG. 13A, and elsewhere. Thus, for example, the software agent can send user credits to a Web database for credit processing.

Next the software agent determines if data is valid (step 1908). Data is valid so long as any security algorithms, encryptions, or checksums have not been altered on the data packets. Data is also valid so long as the data has not been altered by the user or by third parties. Thus, if a user attempts to alter a data file, then the software agent will know that the data is invalid. If data is valid, then the plug-in associated with the software agent updates user credits for the corresponding user (step 1910). In this illustrative example, the software agent attempts to send data regardless of whether the data is valid, with the plug-in performing step 1910. In another illustrative example, the software agent itself performs step 1910 and updates user credits. The process then returns to step 1900 and the entire process repeats. However, if data is not valid, then the software agent denies an update of user credits for the corresponding user (step 1912). Again, the process returns to step 1900 and the entire process repeats. In any case, at step 1900, if credits are not to be updated, then the process terminates.

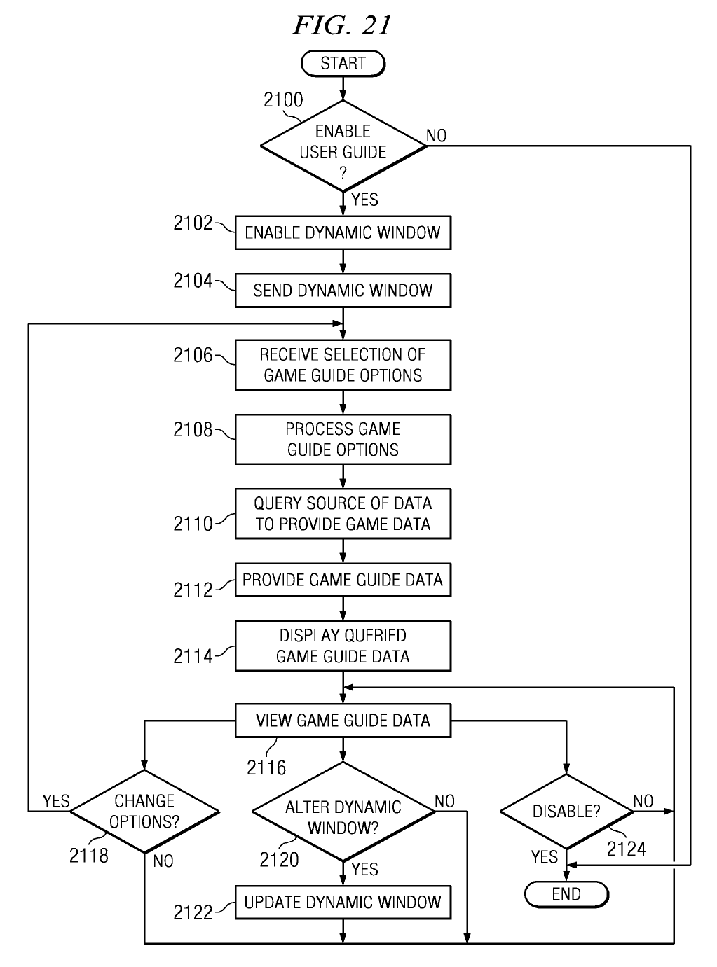

FIG. 20 is a flowchart of a process for configuring a software agent to provide a user with game guide data during game play in accordance with an illustrative embodiment of the present invention. This exemplary process may be implemented using a software agent, such as software agent 301 in FIG. 3, located on or executed on a data processing system, including a client data processing system, a server data processing system, or a combination of client data processing systems and server data processing systems. Examples of client data processing systems include clients 110, 112, and 114 in FIG. 1, and a client can also be a local data processing system. Examples of server data processing systems include servers 104 and 106 in FIG. 1. The illustrative examples described herein can also be implemented on other data processing systems, such as but not limited to personal digital assistants (PDAs), cell phones, laptop computers, and other data processing systems. In an illustrative example, a local data processing system is a data processing system operated by an end user of an online game.

As used herein, a game server is a data processing system on which the software agent or a plug-in associated with the software agent can be loaded. In a non-limiting illustrative embodiment, only the plug-in associated with the software agent is loaded on the game server and the software agent itself is loaded on the local data processing system.

In an illustrative embodiment, a remote game server is a game server that is a remote server or a remote data processing system, with a remote game server also being referred to as an online gaming server. A remote server is any server that is distinct from a local data processing system and that is located in a different geographical location from the local data processing system.

However, in another illustrative embodiment, a game server can also be a local game server. A local game server can be a server of a local area network, or can be a software construct executed by an operating system on a single local computer. In this illustrative example, the local computer hosts both the software agent, such as agent 2300 in FIG. 23A, and the associated plug-in component, such as plug-in component 2306 in FIG. 23B.

Thus, a server session can be executed on the same data processing system that is executing a local session. In this case, the software agent and the associate plug-in still operates in the same manner as in the case where the local session is executed on a local data processing system and the server session is executed on a remote data processing system or remote game server.

The process shown in FIG. 20 can be executed during the process shown in FIG. 15. For example, the process of configuring a software agent to provide a user with game guide data during game play can be performed while the user is playing a game and the software agent or a plug-in application on a remote game server are collecting game play data. The process shown in FIG. 20 can be performed in whole or part by a plug-in application loaded on a remote game server. In this case, the plug-in application communicates with the software agent and works with the software agent to accomplish the method shown in FIG. 20. Reference to the term software agent in FIG. 20 can refer to the software agent loaded or executed on a local computer, a related plug-in application loaded or executed on a remote game server, or a combination thereof.

The process shown in FIG. 20 can also be executed during the processes shown in FIG. 1 through FIG. 13B, and other processes described herein. Thus, the process of configuring a software agent to provide a user with game guide data during game play can be performed with respect to single player game play on a single local computer, with respect to one or more players playing one or more games on a local network of computers, or with respect to a vast number of players playing one or more games online while interacting with one or more game servers. Reference to the term software agent in FIG. 20 can refer to the software agent loaded or executed on a local computer, a related plug-in application loaded or executed on a remote game server, or a combination thereof.

The process begins as the software agent is launched (step 2000). The software agent then checks preferences (step 2002) regarding game guide data. Preferences include whether the user desires game guide data to be displayed, the source of data containing game guide data, and other preferences. The preferences may be presented to a user via a menu of game guide options selectable to control the display of game guide data. The software agent then determines if game guide data exists (step 2004). If game guide data does not exist, then the process terminates. However, if game guide data does exist, then the software agent requests initial game guide data (step 2006). Initial game guide data can be basic game information to be displayed in the user interface, such as the name of the game, whether game guide data should be displayed, or other data or information regarding the game.

In one embodiment, the source of data containing game guide data is a local database that provides the initial game guide data to the software agent (step 2008). In alternative embodiments, the source of data containing game guide data can be a remote database, user-provided data, a local file, a remote file, a Website, results of a search, and results of an Internet search. In any case, the software agent loads the initial game guide data (step 2010), with the process terminating thereafter.

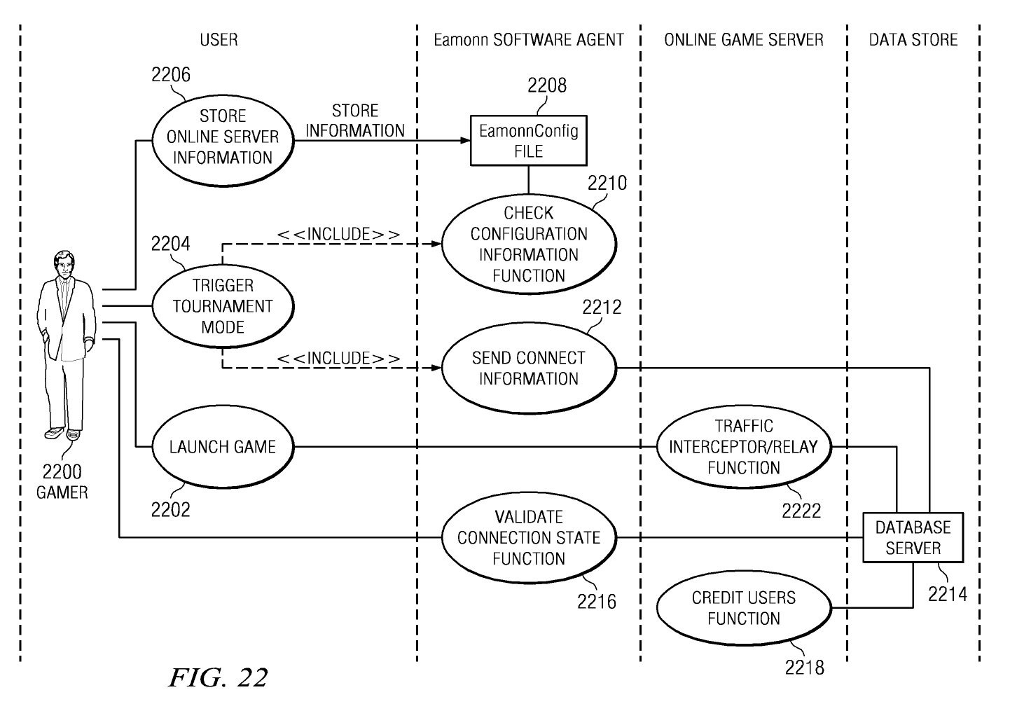

FIG. 21 is a flowchart of a process for displaying game guide data during game play in accordance with an illustrative embodiment of the present invention. This exemplary process may be implemented using a software agent, such as software agent 301 in FIG. 3, located on or executed on a data processing system, including a client data processing system, a server data processing system, or a combination of client data processing systems and server data processing systems. Examples of client data processing systems include clients 110, 112, and 114 in FIG. 1, and a client can also be a local data processing system. Examples of server data processing systems include servers 104 and 106 in FIG. 1. The illustrative examples described herein can also be implemented on other data processing systems, such as but not limited to personal digital assistants (PDAs), cell phones, laptop computers, and other data processing systems. In an illustrative example, a local data processing system is a data processing system operated by an end user of an online game.

As used herein, a game server is a data processing system on which the software agent or a plug-in associated with the software agent can be loaded. In a non-limiting illustrative embodiment, only the plug-in associated with the software agent is loaded on the game server and the software agent itself is loaded on the local data processing system.

In an illustrative embodiment, a remote game server is a game server that is a remote server or a remote data processing system, with a remote game server also being referred to as an online gaming server. A remote server is any server that is distinct from a local data processing system and that is located in a different geographical location from the local data processing system.

However, in another illustrative embodiment, a game server can also be a local game server. A local game server can be a server of a local area network, or can be a software construct executed by an operating system on a single local computer. In this illustrative example, the local computer hosts both the software agent, such as agent 2300 in FIG. 23A, and the associated plug-in component, such as plug-in component 2306 in FIG. 23B.

Thus, a server session can be executed on the same data processing system that is executing a local session. In this case, the software agent and the associate plug-in still operates in the same manner as in the case where the local session is executed on a local data processing system and the server session is executed on a remote data processing system or remote game server.

The process shown in FIG. 21 can be performed after the process shown in FIG. 20; however, the process shown in FIG. 20 need not necessarily be performed before the process shown in FIG. 21 to operate. For example, if the software agent already has game guide data loaded, or if no initial game guide data is needed, then the process shown in FIG. 20 need not be performed before the process shown in FIG. 21.

The process shown in FIG. 21 can be executed during the process shown in FIG. 15. For example, the process of configuring a software agent to provide a user with game guide data during game play can be performed while the user is playing a game and the software agent or a plug-in application on a remote game server are collecting game play data. The process shown in FIG. 21 can be performed in whole or part by a plug-in application loaded on a remote game server. In this case, the plug-in application communicates with the software agent and works with the software agent to accomplish the method shown in FIG. 21. Reference to the term software agent in FIG. 21 can refer to the software agent loaded or executed on a local computer, a related plug-in application loaded or executed on a remote game server, or a combination thereof.

The process shown in FIG. 21 can also be executed during the processes shown in FIG. 1 through FIG. 13B, and other processes described herein. Thus, the process of configuring a software agent to provide a user with game guide data during game play can be performed with respect to single player game play on a single local computer, with respect to one or more players playing one or more games on a local network of computers, or with respect to a vast number of players playing one or more games online while interacting with one or more game servers. Reference to the term software agent with respect to the description of FIG. 21 can refer to the software agent loaded or executed on a local computer, a related plug-in application loaded or executed on a remote game server, or a combination thereof.

The process begins as the software agent determines if the user guide is enabled (step 2100). In an illustrative example, the user guide can be enabled or disabled by a user using a hot key, keystroke combination, or other controller input. The user guide can also be enabled or disabled using a text command or by checking a box within a display window within the game or within the software agent. If the user guide is not enabled, the process terminates.

In an illustrative example, a user guide includes any guide, information, help data, or other data that the user may use during game play. Examples of game guide data include hints, tips, walk-throughs, user manual data, game-related information tables, maps, help files, hotkey maps, user manuals, responses to questions from other users or from employees of the game company during a live chat, cheats (where cheating is allowed), or any other game guide data of interest. A source of game guide data can be provided locally as part of stored game files, or as part of other stored files. In addition, a source of game guide data can be external to the game. A source of game guide data external to the game is any source of data that is not packaged with or otherwise a part of the game. Instead, the source of data external to the game is provided remotely, such as from a remote Web site or a remote database. Thus, for example, the game guide data can be imported from Web sites related to the game, including those Web sites not officially supported, sponsored, or operated by the game company or game designer. Game guide data can also be provided by live users via a chat, by user-defined files, or by any other source of game related information.

If the user guide is enabled, then the software agent enables a dynamic window (step 2102). The software agent then sends the dynamic window to the user (step 2104). A dynamic window is a window that appears within a game or external to the game, but is contained or owned by a process external to the game. In particular, the software agent controls the dynamic window and what appears in the dynamic window. Thus, the software agent, responsive to user input, controls the game guide data that appears in the dynamic window. A dynamic window can be implemented using class objects, such as those shown in FIG. 25. The game guide data can appear as text or an illustration that appears in a form that disrupts game play as little as possible, though the user should be able to understand and use the game guide data. An illustration can be an icon, a picture, a map, or any other form of pictorial means of displaying information. In an illustrative example, the game guide data is presented without interruption of game play. Thus, the dynamic window does not interfere with mouse, keyboard, joystick, or game controller functions. In another illustrative embodiment, game play can be interrupted by the dynamic window; however, preferably the user requests the dynamic window and the game guide in this case. In this manner, a user can search or review the game guide data while the game is paused.

After sending the dynamic window to the user at step 2104, the software agent receives user input regarding a selection of game guide options (step 2106). In one embodiment, the dynamic window may display a menu of game guide options for a user's selection. Game guide options include defining what kind of game guide data a user desires to receive. For example, a user may desire only to be shown maps, but not cheats or other information. A user can also use the game guide options to display certain aspects of a game, such as walkthroughs for a particular level, tips for defeating a particular obstacle in the game, game-related strategies and tactics, or other game-specific information.

Once received, the software agent processes the game guide options (step 2108). In one embodiment, the software agent queries a local database to provide game data (step 2110). In alternative embodiments, the source of data containing game guide data can be a remote database, user-provided data, a local file, a remote file, a Website, results of a search, results of an Internet search, a transmission of a query to a live user in using a chat or instant message technology, the receipt of user-defined input, or the receipt or query of other files located either locally or remotely. In any case, the software agent provides the game guide data (step 2112) to the user by displaying the results of the query to the game guide data (step 2114). The user may then view the game guide data (step 2116) in the display window.

The software agent then takes several actions simultaneously. For example, the software agent determines whether to change the game guide options (step 2118) described with respect to step 2106. If the game guide options are to be changed, then the process returns to step 2106. If the game guide options are not to be changed, then the process returns to step 2116 and repeats. Thus, in an illustrative embodiment, the user can change what game guide data is displayed in the dynamic window during game play or outside of game play.

At the same time, the software agent determines whether to alter the dynamic window (step 2120). If the software agent receives input to alter the dynamic window, then the software agent updates the dynamic window appropriately (step 2122). The process then returns to step 2116 and repeats. Thus, in an illustrative embodiment, the user can change or alter the dynamic window during or outside of game play. For example, the user can change the size of the dynamic window, change the appearance of the dynamic window, cause the dynamic window to go into the background, or to change or alter the dynamic window in any desired way.

At the same time, the software agent determines whether to disable the game guide (step 2124). If not, then the process returns to step 2116 and all related processes continue. However, if the software agent determines to disable the game guide, then the process and all related processes terminate. In an illustrative example, a user can disable the game guide and the dynamic window by entering a hot key, keystroke combination, text command, voice or audio input, or by means of any other controller input. Thus, a user can enable and disable the game guide and the dynamic window one or more times each during game play or outside of game play.

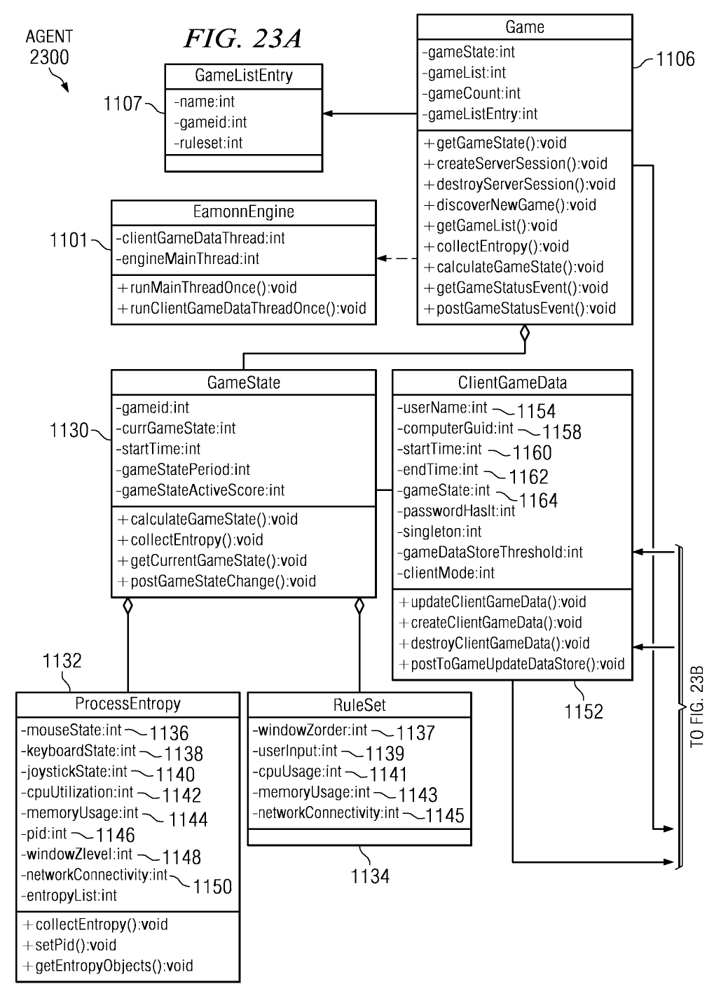

FIG. 22 is a use case diagram illustrating use cases performed by a gamer user, a software agent, a server, and a data store in accordance with an illustrative embodiment of the present invention. This exemplary use case may be implemented using a software agent, such as software agent 301 in FIG. 3, located on or executed on a data processing system, including a client data processing system, a server data processing system, or a combination of client data processing systems and server data processing systems. Examples of client data processing systems include clients 110, 112, and 114 in FIG. 1, and a client can also be a local data processing system. Examples of server data processing systems include servers 104 and 106 in FIG. 1. The illustrative examples described herein can also be implemented on other data processing systems, such as but not limited to personal digital assistants (PDAs), cell phones, laptop computers, and other data processing systems. In an illustrative example, a local data processing system is a data processing system operated by an end user of an online game.

As used herein, a game server is a data processing system on which the software agent or a plug-in associated with the software agent can be loaded. In a non-limiting illustrative embodiment, only the plug-in associated with the software agent is loaded on the game server and the software agent itself is loaded on the local data processing system.

In an illustrative embodiment, a remote game server is a game server that is a remote server or a remote data processing system, with a remote game server also being referred to as an online gaming server. A remote server is any server that is distinct from a local data processing system and that is located in a different geographical location from the local data processing system.

However, in another illustrative embodiment, a game server can also be a local game server. A local game server can be a server of a local area network, or can be a software construct executed by an operating system on a single local computer. In this illustrative example, the local computer hosts both the software agent, such as agent 2300 in FIG. 23A, and the associated plug-in component, such as plug-in component 2306 in FIG. 23B.

Thus, a server session can be executed on the same data processing system that is executing a local session. In this case, the software agent and the associate plug-in still operates in the same manner as in the case where the local session is executed on a local data processing system and the server session is executed on a remote data processing system or remote game server.

The use case shown in FIG. 22 shows an overview of the processes shown in FIG. 14 through FIG. 21. The use case shown in FIG. 22 can be performed in whole or part by a plug-in application loaded on a remote game server. In this case, the plug-in application communicates with the software agent and works with the software agent to accomplish the use case shown in FIG. 22. Reference to the term software agent in FIG. 22 can refer to the software agent loaded or executed on a local computer, a related plug-in application loaded or executed on a remote game server, or a combination thereof.

The user, in this illustrative example gamer 2200, launches a game 2202 on a local data processing system. Gamer 2200 also triggers tournament mode 2204. Gamer 2200 also stores online server information 2206 on the local computer. Note that, tournament mode can also be activated automatically by the software agent, by the remote game server, or by some other means. Tournament mode is a particular mode of operation for the software agent. In tournament mode, the software agent that operates on the local computer of gamer 2200 will operate in conjunction with a plug-in application operated on the remote game server, as described with respect to FIG. 14 through FIG. 21.

In the illustrative example of FIG. 22, the trade name of the software agent is Eamonn. Online server information is stored in an EamonnConfig file 2208, which is part of the Eamonn software agent. EamonnConfig file 2208 is used by check configuration information function 2210 of the software agent as part of the software agent startup process, as described with respect to FIG. 15. The check configuration information function 2210 of the software agent also includes the fact that tournament mode 2204 has been triggered when configuring the software agent, as described with respect to FIG. 15.

Additionally, send connect information function 2212 of the Eamonn software agent includes the fact that tournament mode 2204 has been triggered when sending connection information to database server 2214. Database server 2214 is, in this illustrative example, a remote server adapted to process game play data and update user credits, as described above. Thus, database server 2214 can be server 320 in FIG. 3, database server 728 in FIG. 7, server 808 in FIGS. 8A-8B, database server 1041 in FIG. 10C, or a server in FIG. 15 through FIG. 21 that performs a similar function. In addition, the Eamonn software agent validates a connection state, as described with respect to FIG. 15, via validate connection state function 2216.

At the online game server, a traffic interceptor or relay function 2222 validates game traffic. Game traffic can include game characteristics, game play data, and the number and identities of users playing a game. Traffic interceptor or relay function 2222 communicates such information to database server 2214. Further, at the online game server, credit users function 2218 generates and transmits user credits to database server 2214, as described with respect to FIG. 19.

FIGS. 23A-23B are class diagrams illustrating exemplary classes used to implement aspects of the present invention in accordance with an illustrative embodiment of the present invention. Except as noted, FIGS. 23A-23B are the same as FIGS. 11A-11B, with similar reference numerals referring to similar objects. The description to FIGS. 11A-11B also applies to FIGS. 23A-23B.

As shown in FIG. 23B, a gamer may launch a game via user interface 1124 by invoking launchGame 1118 function, invoke a chat using invokeChat 1114 function of chat 1108, and view a list of buddies by invoking viewBuddies 1110 function of chat 1108. In addition, the gamer may update any options available to them in user interface 1124. When the gamer synchronizes with the software agent, updates to static content 1170 or dynamic content 1172 will be requested by the software agent and then sent by the Web server, such as Web server 1040 in FIG. 10C.

In addition, FIG. 23B shows EamonnConfig function 2304, which communicates with UserInterface 1124. EamonnConfig function 2304 allows the software agent, Eamonn, to be configured for tournament mode. As described above with respect to FIG. 14 through FIG. 18, in tournament mode the software agent can interact with a plug-in loaded on a remote game server.

Furthermore, FIG. 23B shows ServerGame function 2306. ServerGame function 2306 is a plug-in that operates on a remote game server. ServerGame function 2306 interacts with the user's computer via a communication function, such as gSoap 1174, and UserInterface 1124. ServerGame function 2306 allows creation and reporting of user credits earned and tracking of game performance data directly at the remote game server.

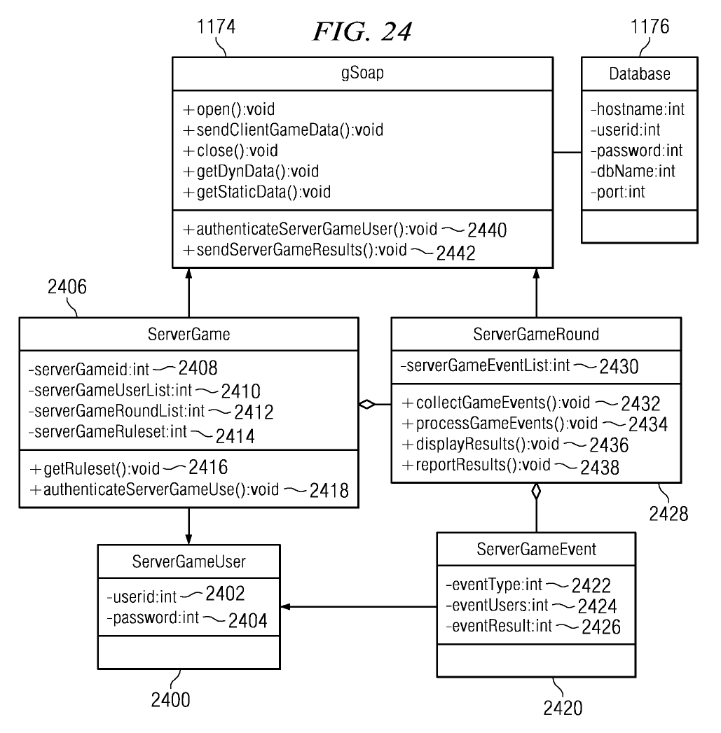

FIG. 24 is a class diagram illustrating exemplary classes used to implement aspects of the present invention in an online environment in accordance with an illustrative embodiment of the present invention. The exemplary classes shown in FIG. 24 can be part of or in addition to ServerGame 2306 shown in FIG. 23B. Thus, FIG. 24 illustrates additional embodiments of the plug-in portion of a software agent, as described with respect to FIG. 14 through FIG. 21. The exemplary classes can be implemented in hardware or in software using computer usable program code stored in a computer usable medium or by using any suitable means for implementing computer instructions.

ServerGameUser 2400 is a class that represents a particular user of a game portion operating on a remote server. ServerGameUser 2400 includes at least user identification 2402 and password 2404 so that the user can be uniquely identified in a secure manner. After ServerGameUser 2400 receives a valid user identification 2402 and password 2404, ServerGame class 2406 is instantiated. ServerGame function 2406 includes serverGameId 2408, serverGameUserList 2410, serverGameRoundList 2412, and serverGameRuleset 2414. ServerGame class 2406 also includes getRuleset function 2416 and authenticateServerGameUse 2418. Additionally, ServerGameEvent class 2420 is also created. ServerGameEvent class 2420 includes eventType 2422, eventUsers 2424, and eventResult 2426.

Both ServerGameEvent class 2420 and ServerGame class 2406 interact with ServerGameRound class 2428. ServerGameRound class 2428 includes serverGameEventList 2430, collectGameEvents function 2432, processGameEvents function 2434, displayResults function 2436, and reportResults function 2438.

Both ServerGame class 2406 and ServerGameRound 2428 interact with gSoap class 1174, which is similar to gSoap class 1174 in FIGS. 11A-11B. gSoap class 1174 includes authenticateServerGameUser function 2440 and sendServerGameResults function 2442. gSoap class 1174 interacts with database class 1176, which is similar to database 1176 in FIG. 11B.

FIG. 25 is a class diagram illustrating exemplary classes used to implement a dynamic interactive window during game play in accordance with an illustrative embodiment of the present invention. The exemplary classes shown in FIG. 25 can be used to implement a dynamic window for issuing a challenge prompt or displaying a game guide, as described with respect to FIG. 14 through FIG. 21. The exemplary classes can be implemented in hardware or in software using computer usable program code stored in a computer usable medium or by using any suitable means for implementing computer instructions. As used herein, the term display can also refer to a dynamic window described in FIG. 14 through FIG. 21.

EamonnRemoteDisplayModule class 2500 is a class describing a module for a software agent for creating a display window within or over a game. EamonnRemoteDisplayModule class 2500 includes install function 2502, uninstall function 2504, and displayUpdate function 2506. These functions allow install, uninstall, and update of the software agent's display window function. EamonnRemoteDisplayModule class 2500 operates with EamonnRemoteDisplayConnector class 2508 to install a display module, choose an injection method for the display window, send data to the display, and uninstall the display module. Thus, EamonnRemoteDisplayConnector class 2508 contains instalIDisplayModule function 2510, chooseInjectionMethod function 2512, sendToDisplay function 2514, and uninstalIDisplayModule function 2516.

In turn, EamonnRemoteDisplayConnector class 2508 operates with EamonnRemoteDisplayManger class 2518 to display either challenge prompts or game guide data. Thus, EamonnRemoteDisplayManger class 2518 includes takeDisplayControl function 2520, displayPromptOptions function 2522, setUserHotKeys function 2524, managersends function 2526, and takeRequests function 2528. Additionally, EamonnRemoteDisplayManger class 2518 operates with ChallengePrompt class 2530 and GameGuide class 2540.

ChallengePrompt class 2530 includes a number of functions. In particular, ChallengePrompt class 2530 includes moveForward function 2532, moveBack function 2534, getCurrentView 2536, and finalAnswer function 2538. Thus, ChallengePrompt class 2530 allows the display window to receive input regarding answers to prompts displayed in the display window.

GameGuide class 2540 includes a number of functions. In particular, GameGuide class 2540 includes loadData function 2542 and queryData function 2544. Thus, GameGuide class 2540 allows users to load data from sources other than help files provided by the game itself and to query and display that loaded data while playing the game.

Thus, the methods and classes shown in FIG. 14 through FIG. 25 provide for a computer implemented method for monitoring game play behavior of a user in an online gaming environment. In an illustrative example, game play behavior is game play data. Game play data is data that reflects how users are playing the game. The computer implemented method includes, responsive to detecting execution of a game, monitoring gaming characteristics of the user. Examples of gaming characteristics that the software agent monitors include mouse usage, joystick usage, keyboard usage, user CPU utilization, user active window, user memory usage, user network connectivity, and the like. In an illustrative example, the game interacts with a remote server. The method also includes identifying a game state based on the gaming characteristics. A game state is a state of a game. Examples of game states include active, inactive, idle, paused, partially active, or other game states. The method further includes collecting game play data of the user if the game state is changed while the game is executing. This method further includes collecting game play data in tournament mode even if the game state is not changing. In this latter embodiment, game play data can be accumulated based on kills, levels accomplished, or other benchmarks.

Optionally, the method further includes reporting the game play data for processing. In an illustrative example, reporting the game play data means transmitting the game play data to another data processing system. In another illustrative example, reporting the game play data means storing the game play data in a storage device. Still further optionally, the steps of monitoring and identifying are performed by a software agent located on a local data processing system, and the step of collecting is performed by a plug-in application located on the remote server. In this case, the plug-in application communicates with the software agent.

In summary, aspects of the present invention provide a model that collects online and offline user game play data and credits the users according to the collected data. The user game play data is post sales market research data that is otherwise skewed or biased. In addition to collecting game play data, the present invention provides a software agent that performs various functionalities, including user account management, chat management, game list management, and the like. Furthermore, aspects of the present invention provide game play data for a single-player gamer that is non-biased. Furthermore, another aspect of the present invention involves how the company utilizes the key aspects of the data to provide unique services, for example, dynamic data to initiate an interactive environment for the users, competitive analysis amongst users, as well as data used to promote dynamically efficient targeted advertisements within live games. Furthermore, another aspect of the present invention involves using a plug-in application at a remote game server to interact with a software agent loaded locally to accomplish the goals of collecting game play data and awarding user credits to users for time played and game performance. Furthermore, other aspects of the present invention involve displaying a challenge prompt, to a user to ensure that collection of game data is a true representation of user game play, and displaying game data or help files downloaded to, loaded to, or created by a user.

Additionally, the illustrative embodiments provide for a computer implemented method, a data processing system, and computer program product provided for monitoring user game-playing behavior and reporting game play data in a gaming environment. A software agent is provided for monitoring gaming characteristics of the user responsive to a launch of a game by a user. The software agent also identifies a game state based on the gaming characteristics. The software agent collects game play data of the user if the game state is changed, and reports the game play data for processing. Game play data can be collected in tournament mode even if the game state is not changing. In this latter embodiment, game play data can be accumulated based on kills, levels accomplished, or other benchmarks.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or tangible computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), and digital video disc (DVD). The medium may be tangible or intangible depending on the implementation.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

As used herein, the term “means for monitoring” refers to processors; such as processing unit 206 in FIG. 2; servers, such as servers 104 and 106 in FIG. 1; clients, such as clients 110, 112, and 114 in FIG. 1; software agents, such as software agent 301 in FIG. 3, client/agent 802 in FIGS. 8A-8B, agent 1000 in FIGS. 10A-10C, EamonnEngine 1101 in FIG. 11A, server 2302 in FIG. 23B; a plug-in program, such as a plug-in program described in reference to FIG. 14 through FIG. 25; hardware for performing the functions of an agent or plug-in; databases; storage devices; or any other means for monitoring user behavior, game play data, or gaming statistics.

As used herein, the term “means for identifying” refers to processors; such as processing unit 206 in FIG. 2; servers, such as servers 104 and 106 in FIG. 1; clients, such as clients 110, 112, and 114 in FIG. 1; software agents, such as software agent 301 in FIG. 3, client/agent 802 in FIGS. 8A-8B, agent 1000 in FIGS. 10A-10C, EamonnEngine 1101 in FIG. 11A, server 2302 in FIG. 23B; a plug-in program, such as a plug-in program described in reference to FIG. 14 through FIG. 25; hardware for performing the functions of an agent or plug-in; databases; storage devices; or any other means for identifying a game state while playing a game.

As used herein, the term “means for collecting” refers to processors; such as processing unit 206 in FIG. 2; servers, such as servers 104 and 106 in FIG. 1; clients, such as clients 110, 112, and 114 in FIG. 1; software agents, such as software agent 301 in FIG. 3, client/agent 802 in FIGS. 8A-8B, agent 1000 in FIGS. 10A-10C, EamonnEngine 1101 in FIG. 11A, server 2302 in FIG. 23B; a plug-in program, such as a plug-in program described in reference to FIG. 14 through FIG. 25; hardware for performing the functions of an agent or plug-in; databases; storage devices; communications devices; or any other means for collecting game play data.

As used herein, the term “means for reporting” refers to processors; such as processing unit 206 in FIG. 2; servers, such as servers 104 and 106 in FIG. 1; clients, such as clients 110, 112, and 114 in FIG. 1; software agents, such as software agent 301 in FIG. 3, client/agent 802 in FIGS. 8A-8B, agent 1000 in FIGS. 10A-10C, EamonnEngine 1101 in FIG. 11A, server 2302 in FIG. 23B; a plug-in program, such as a plug-in program described in reference to FIG. 14 through FIG. 25; hardware for performing the functions of an agent or plug-in; databases; storage devices; communications devices; or any other means for reporting data.

What is claimed is:

1. A computer implemented method for presenting a user guide for supplementing game play, the computer implemented method comprising:
querying a source of data containing game guide data corresponding to a game, wherein the game is executing on a data processing system, and wherein the source of data is external to the game; and
presenting, while the game is executing in a foreground, the game guide data to the user in a dynamic window.

2. The computer implemented method of claim 1 further comprising:
responsive to detecting an activation of the user guide, displaying a menu of game guide options in the dynamic window.

3. The computer implemented method of claim 2, wherein the selection of game guide options is made at a time selected from the group consisting of during game play and outside of game play.

4. The computer implemented method of claim 1, further comprising:
responsive to receiving input from the user to alter the dynamic window, updating the dynamic window according to the input.

5. The computer implemented method of claim 4, wherein the dynamic window is altered by at least one of changing the size of the dynamic window, changing the appearance of the dynamic window, and displaying the dynamic window in a background of the game.

6. The computer implemented method of claim 4, wherein the dynamic window is implemented using class objects.

7. The computer implemented method of claim 1, wherein the user guide is capable of being enabled and disabled, during game play, by using at least one of a hot key, a combination of keystrokes, controller input, audio input, and entering a text command.

8. The computer implemented method of claim 1, wherein the game guide data comprises at least one of hints, tips, walk-throughs, user manual data, game-related information tables, maps, help files, hotkey maps, user manuals, responses to questions from other users or from employees of the game company during a live chat, and cheats.

9. The computer implemented method of claim 8, wherein the game guide data is presented to a user in at least one of text, audio, and an illustration.

10. The computer implemented method of claim 1, wherein the source of data comprises at least one of a local database, a remote database, user-provided data, a local file, a remote file, a Website, results of a search, and results of an Internet search.

11. A computer program product comprising:
a computer usable medium having computer usable program code for presenting a user guide for supplementing game play, the computer program product comprising:
computer usable program code for querying a source of data containing game guide data corresponding to a game, wherein the game is executing on a data processing system, and wherein the source of data is external to the game; and
computer usable program code for presenting, while the game is executing in a foreground, the game guide data to the user in a dynamic window.

12. The computer program product of claim 11 further comprising:
computer usable program code for displaying a menu of game guide options in the dynamic window in response to detecting an activation of the user guide.

13. The computer program product of 12, wherein the selection of game guide options is made at a time selected from the group consisting of during game play and outside of game play.

14. The computer program product of claim 11, further comprising:
computer usable program code for updating the dynamic window according to the input in response to receiving input to alter the dynamic window.

15. The computer program product of claim 14, wherein the dynamic window is altered by at least one of changing the size of the dynamic window, changing the appearance of the dynamic window, and displaying the dynamic window in a background of the game.

16. The computer program product of claim 11, wherein the user guide is capable of being enabled and disabled, during game play, by using at least one of a hot key, a combination of keystrokes, controller input, audio input, and entering a text command.

17. The computer program product of claim 11, wherein the game guide data comprises at least one of hints, tips, walk-throughs, user manual data, game-related information tables, maps, help files, hotkey maps, user manuals, responses to questions from other users or from employees of the game company during a live chat, and cheats.

18. The computer program product of claim 17, wherein the game guide data is presented to a user in at least one of text, audio, and an illustration.

19. The computer program product of claim 11, wherein the source of data comprises at least one of a local database, a remote database, user-provided data, a local file, a remote file, a Website, results of a search, and results of an Internet search.

20. A gaming system for presenting a user guide for supplementing game play, the gaming system comprising:
a bus;
a storage device connected to the bus, wherein the storage device contains computer usable code;
a communications unit connected to the bus; and
a processing unit connected to the bus, wherein the processing unit executes the computer usable code to:
query a source of data containing game guide data corresponding to a game, wherein the game is executing on a data processing system, and wherein the source of data is external to the game; and
present, while the game is executing in a foreground, the game guide data to the user in a dynamic window.
